(19) United States
(12) Patent Application Publication
(10) Pub. No.: US 2011/0196673 A1
(43) Pub. Date: Aug. 11, 2011

(54) CONCEALING LOST PACKETS IN A SUB-BAND CODING DECODER

(75) Inventors: Amit Sharma, San Diego, CA (US); Jeremy P. Toman, San Diego, CA (US); Hyun Jin Park, San Diego, CA (US); Sang-Uk Ryu, San Diego, CA (US)

(73) Assignee: QUALCOMM Incorporated, San Diego, CA (US)

(21) Appl. No.: 13/014,572

(22) Filed: Jan. 26, 2011

Related U.S. Application Data
(60) Provisional application No. 61/303,560, filed on Feb. 11, 2010.
(60) Provisional application No. 61/324,228, filed on Apr. 14, 2010.

(51) Int. Cl. G10L 11/04

(52) U.S. Cl. 704/207; 704/E11.006

(57) ABSTRACT

An electronic device for reconstructing a lost packet in a Sub-Band Coding (SBC) decoder is described. The electronic device includes a processor and instructions stored in memory. The electronic device detects a lost packet, obtains a zero-input response of a synthesis filter bank and obtains a coarse pitch estimate. The electronic device also obtains a fine pitch estimate based on the zero-input response and the coarse pitch estimate. The electronic device selects a last pitch period based on the fine pitch estimate and uses samples from the last pitch period for the lost packet.

### RELATED APPLICATIONS

This application is related to and claims priority from U.S. Provisional Patent Application Ser. No. 61/303,560 filed Feb. 11, 2010, for “An Efficient Packet Loss Concealment (PLC) Scheme in SBC Decoder for Wideband Speech Communications over BlueTooth” and U.S. Provisional Patent Application Ser. No. 61/324,228 filed Apr. 14, 2010, for “An Efficient Packet Loss Concealment (PLC)

Scheme in a Subband Coding Decoder for Wide-Band Speech Communications.”

### TECHNICAL FIELD

The present disclosure relates generally to electronic devices. More specifically, the present disclosure relates to concealing lost packets in a Sub-Band Coding (SBC) decoder.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Many electronic devices are used in conjunction with audio or sound information, such as music or voice data, for example. This audio or sound information can enable an electronic device to reproduce sounds. Some electronic devices communicate with other electronic devices. For example, one kind of an electronic device is a wireless communication device, such as a cellular phone. Some wireless communication devices or other electronic devices can receive audio or sound information. For example, a wireless communication device may receive voice information from another electronic device.

Some audio or sound information might be lost, for example, when an electronic device is receiving the audio or sound information. For instance, a wireless communication device might lose one or more packets of voice information or data during a phone call. Lost audio or sound information can cause a degraded user experience. As can be seen from this discussion, improved systems and methods for handling lost audio or sound information may be beneficial.

### SUMMARY

An electronic device for reconstructing a lost packet in a Sub-Band Coding (SBC) decoder is disclosed. The electronic device includes a processor and instructions stored in memory. The electronic device detects a lost packet and obtains a zero-input response of a synthesis filter bank. The electronic device also obtains a coarse pitch estimate and obtains a fine pitch estimate based on the zero-input response and the coarse pitch estimate. The electronic device further selects a last pitch period based on the fine pitch estimate and uses samples from the last pitch period for the lost packet.

The coarse pitch estimate may be obtained by computing autocorrelations of sub-band samples. The sub-band samples may not have been synthesized. The electronic device may also overlap-add at least some of the samples from the last pitch period with the zero-input response. The fine pitch estimate is obtained by computing correlations of the zero-input response with previously decoded samples.

The electronic device may further detect an additional lost packet and may use samples from the last pitch period for the additional lost packet. The electronic device may also fade the samples from the last pitch period. The electronic device may also use samples from the last pitch period for a plurality of additional lost packets.

The electronic device may also detect a correctly decoded packet or frame, may use samples from the last pitch period for a range of undesirable samples and may overlap-add samples from the last pitch period with transition samples. Using the samples from the last pitch period for the lost packet may include copying the samples into the lost packet.

The SBC decoder may be used to decode wide-band speech signals. The electronic device may be a wireless communication device. The wireless communication device may be a Bluetooth device. No additional delay may be used for reconstructing the lost packet compared to decoding a viable packet by the SBC decoder.

A method for reconstructing a lost packet in a Sub-Band Coding (SBC) decoder is also disclosed. The method includes detecting a lost packet and obtaining, on an electronic device, a zero-input response of a synthesis filter bank. The method also includes obtaining a coarse pitch estimate and obtaining a fine pitch estimate based on the zero-input response and the coarse pitch estimate. The method further includes selecting a last pitch period based on the fine pitch estimate and using samples from the last pitch period for the lost packet.

A computer-program product for reconstructing a lost packet in a Sub-Band Coding (SBC) decoder is also disclosed. The computer-program product includes a non-transitory tangible computer-readable medium with instructions thereon. The instructions include code for causing an electronic device to detect a lost packet and obtain a zero-input response of a synthesis filter bank. The instructions also include code for causing the electronic device to obtain a coarse pitch estimate and obtain a fine pitch estimate based on the zero-input response and the coarse pitch estimate. The instructions further include code for causing the electronic device to select a last pitch period based on the fine pitch estimate and use samples from the last pitch period for the lost packet.

An apparatus for reconstructing a lost packet in a Sub-Band Coding (SBC) decoder is also disclosed. The apparatus includes means for detecting a lost packet and means for obtaining a zero-input response of a synthesis filter bank. The apparatus also includes means for obtaining a coarse pitch estimate and means for obtaining a fine pitch estimate based on the zero-input response and the coarse pitch estimate. The apparatus further includes means for selecting a last pitch period based on the fine pitch estimate and means for using samples from the last pitch period for the lost packet.

### BRIEF DESCRIPTION OF THE DRAWINGS

FIG. 1 is a block diagram illustrating one configuration of an electronic device in which systems and methods for Packet Loss Concealment (PLC) or lost packet reconstruction may be implemented;

FIG. 2 is a block diagram illustrating one configuration of a wireless communication device in which systems and methods for Packet Loss Concealment (PLC) or lost packet reconstruction may be implemented;

FIG. 3 is a block diagram illustrating another configuration of a wireless communication device in which systems and methods for Packet Loss Concealment (PLC) or lost packet reconstruction may be implemented;

FIG. 4 is a flow diagram illustrating one configuration of a method for concealing or reconstructing lost packets in a Sub-Band Coding (SBC) decoder;

FIG. 5 is a block diagram illustrating one configuration of several modules for concealing or reconstructing lost packets in a Sub-Band Coding (SBC) decoder;

FIG. 6 is a flow diagram illustrating a more specific configuration of a method for concealing or reconstructing lost packets in a Sub-Band Coding (SBC) decoder;

FIG. 7A illustrates lost or missing packet detection. An electronic device 102 may receive and/or decode SBC encoded audio (e.g., voice or speech);

FIG. 7B illustrates the generation of a zero-input response;

FIG. 7C illustrates the determination of a coarse pitch estimate or period;

FIG. 7D illustrates the determination of a fine pitch estimate or last pitch period;

FIG. 7E illustrates using a last pitch period for the lost packet and overlap-adding a zero-input response with samples from the last pitch period;

FIG. 7F illustrates a concealed or reconstructed packet or frame;

FIG. 8 is a block diagram illustrating one configuration of several modules for concealing or reconstructing lost packets in a Sub-Band Coding (SBC) decoder;

FIG. 9 is a flow diagram illustrating another configuration of a method for concealing or reconstructing lost packets in a Sub-Band Coding (SBC) decoder;

FIG. 10A is a diagram illustrating the detection of an additional lost packet;

FIG. 10B is a diagram illustrating using samples from a last pitch period to conceal or reconstruct an additional lost packet or frame;

FIG. 10C is a diagram illustrating fading samples in a concealed packet or frame;

FIG. 11 is a block diagram illustrating one configuration of several modules that may be used for concealing or reconstructing lost packets in a Sub-Band Coding (SBC) decoder;

FIG. 12 is a flow diagram illustrating one configuration of a method for concealing or reconstructing lost packets in a Sub-Band Coding (SBC) decoder;

FIG. 13A is a diagram illustrating a zero-state response of a correctly decoded packet or frame;

FIG. 13B is a diagram illustrating using samples from a last pitch period for the zero-state response of a correctly decoded packet or frame;

FIG. 14 is a diagram illustrating an example of frame overlap;

FIG. 15 is a block diagram illustrating one configuration of several modules that may be used for concealing or reconstructing lost packets in a Sub-Band Coding (SBC) decoder;

FIG. 16 illustrates various components that may be utilized in an electronic device;

FIG. 17 illustrates certain components that may be included within a wireless communication device; and

FIG. 18 illustrates certain components that may be included within a base station.

### DETAILED DESCRIPTION

As used herein, the term “base station” generally denotes a communication device that is capable of providing access to a communications network. Examples of communications networks include, but are not limited to, a telephone network (e.g., a “land-line” network such as the Public-Switched Telephone Network (PSTN) or cellular phone network), the Internet, a Local Area Network (LAN), a Wide Area Network (WAN), a Metropolitan Area Network (MAN), etc. Examples of a base station include cellular telephone base stations or nodes, access points, wireless gateways and/or wireless routers, for example. A base station may operate in accordance with certain industry standards, such as the Institute of Electrical and Electronics Engineers (IEEE) 802.11a, 802.11b, 802.11g, 802.11n, 802.11ac (e.g., Wireless Fidelity or “Wi-Fi”) standards. Other examples of standards that a base station may comply with include IEEE 802.16 (e.g., Worldwide Interoperability for Microwave Access or “WiMAX”), 3rd Generation Partnership Project (3GPP), 3GPP Long Term Evolution (LTE) and others (e.g., where a base station may be referred to as a NodeB, evolved NodeB (eNB), etc.). While some of the systems and methods disclosed herein may be described in terms of one or more standards, this should not limit the scope of the disclosure, as the systems and methods may be applicable to many systems and/or standards.

As used herein, the term “wireless communication device” generally denotes an electronic device (e.g., access terminal, client device, client station, etc.) that may wirelessly communicate with a base station or other electronic device. A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smart phones, wireless modems, e-readers, tablet devices, gaming systems, etc. Wireless communication devices may operate in accordance with one or more industry standards as described above in connection with base stations. Thus, the general term “wireless communication device” may include wireless communication devices described with varying nomenclatures according to industry standards (e.g., access terminal, user equipment (UE), remote terminal, etc.).

Over the past few years, there has been a strong demand in consumer electronic industries for techniques that enable Wide-Band (WB) speech communications over BlueTooth (BT). As a response to the demand, the BT standards body has selected Sub-Band Coding (SBC) as a mandatory codec for BT's WB speech or voice applications. SBC is a frame-based codec, where an input signal is fragmented into a frame and time samples in the frame are converted by analysis filters to decimated sub-band samples. The sub-band samples in each frequency band are adaptively quantized, and the quantizer indexes are then transmitted to an SBC decoder, along with the quantizer step sizes. In an SBC decoder, the sub-band samples are reconstructed by inverse quantizers and converted back to a time domain signal by synthesis filters.

Unlike the Continuously Variable Slope Delta Modulation (CVSD) codec for Narrow Band (NB) speech over BT, an SBC decoder is known to be sensitive to transmission bit errors, since it tends to produce annoyingly impaired audio for packets corrupted by bit errors. To avoid such degradation, the corrupted packets may be discarded and replaced with a good estimate using packet loss concealment (PLC) or lost packet reconstruction.

Many PLC techniques could be incorporated into an SBC decoder, such as silence insertion, packet repetition, waveform substitution based on pitch analysis and Linear Prediction—(LP) based PLC, etc. Among them, the PLC deployed for the G.711 NB speech codec has been recommended by the BT standards body as a cost-effective solution, due to its capability to produce good audio quality with moderate delay and computational complexity.

When a voice or speech signal (e.g., wide-band voice or speech information) is transmitted between electronic devices (e.g., a Bluetooth transmitter and receiver), one or more packets may be lost. The loss of a packet may cause unwanted signal distortion and artifacts. When a packet of a voice or speech signal is lost, Packet Loss Concealment (PLC) or lost packet reconstruction may by used to reconstruct the lost packet based on received data until another packet is successfully received, thus reducing unwanted signal distortion and artifacts. However, a traditional PLC scheme may require significant processing and memory resources. Furthermore, additional processing and memory resources may be needed when the PLC scheme is applied to a wide-band speech signal (as opposed to narrow band).

When PLC is not used, a wideband speech bit stream encoded by an SBC encoder may be received by an SBC decoder. A bit stream parser may parse and format the bit stream for input into the inverse quantizer. The inverse quantizer reconstructs sub-band samples for input into a synthesis filter bank. The synthesis filter bank converts the reconstructed sub-band samples into time domain (e.g., Pulse Code Modulated (PCM)) samples. The time domain samples may comprise wideband speech decoded by the SBC decoder. If a packet is incorrectly received or lost without PLC, for example, unwanted distortion in the decoded wideband speech may occur as described above.

A review of one traditional PLC scheme is given hereafter for understanding. G.711 is a traditional PLC Telecommunication Standardization Sector (ITU-T) standard. The PLC for a G.711 decoder essentially estimates a lost speech frame by searching for a fragment in the correctly received previous samples that is most similar to the last available samples. The decoder then inserts this fragment between the previous and the next (correctly received) frames.

When a packet of a 10 millisecond (msec) frame is correctly received, the decoded frames are stored in a history buffer of length greater than two times a maximum pitch length. When a packet is lost, the last pitch period is determined in a pitch analysis block. First, a block x of length equal to the maximum pitch length is taken from the latest samples in the history buffer where the maximum pitch length is set to 120. Another block y0 of the same length is also taken in the history buffer with a minimum time lag. A normalized correlation is computed for these two blocks (x and y0) and stored in a local variable R(0). Next, the second block y1 is obtained by taking samples in the history buffer with a time lag incremented by one sample. A normalized correlation R(1) is computed using the two blocks x and y1. These operations are repeated until the time lag is increased to the maximum pitch length. A last pitch period is determined as a time lag that maximizes the normalized correlation.

In summary, G.711 PLC first computes correlations between the latest block and sample blocks in history buffer. Second, it determines the last pitch period where correlation is maximized. Third, it copies the last pitch period into the lost frame. Fourth, it performs a tail overlap add (OLA) for a smooth transition between received and concealed samples. Fifth, it performs head OLA for a seamless transition between concealed samples and the next frame.

It can be seen that pitch analysis may require a significant amount of arithmetic operations, which may exceed the computational complexity of G.711 decoding of a 10 msec frame. In order to reduce the computational burden, the PLC standard employs an algorithm that performs the pitch analysis in a way of coarse estimation and its refinement. A coarse estimate of the last pitch period is obtained by computing correlations for decimated samples at half rate. From the coarse estimate, three candidates for refinement (the coarse estimate and its two neighbors) are compared by computing, for each candidate, the normalized correlations between blocks in the last two pitch periods and by selecting a candidate that maximizes the correlation.

Once the last pitch period is determined in the pitch analysis, the last pitch period in the history buffer is copied into the lost frame. In addition to the samples in the last pitch period, a 3.75 msec sample block right before the last pitch period is also copied and overlap-added (OLA) with the latest segment in the history buffer in order to avoid waveform discontinuity in the frame boundary. From this tail OLA process, it can be seen that the last 3.75 msec of samples in the previous frame (which was already output to an output buffer) are modified in the concealment of the current frame. Thus, when the decoded or concealed frames are output to the output buffer, samples in the frame may be delayed by 3.75 msec to allow for potential modification on the 3.75 msec block. Accordingly, the first 6.25 msec samples in the concealed frame are preceded by the last 3.75 msec in the previous frame and the concatenated frame of 10 msec is finally drained to the output buffer.

When a good packet is received after a loss of packets, the decoded frame is inserted right after the previously concealed frame. However, a waveform discontinuity may exist in the frame boundary. To ensure a seamless transition, a sample block of 3.75 msec is repeated from the previous pitch period and overlap-added with the first 3.75 msec block in the decoded frame. After this modification of the decoded frame, a 10 msec block delayed by 3.75 msec is output to output buffer.

A Sub-Band Coding (SBC) decoder generally reconstructs time domain signals from received sub-band samples. Loss of a single SBC packet means a loss of sub-band samples in the frame. Hence, it may be desirable to design a PLC scheme for an SBC decoder that estimates the lost sub-band samples. However, this task may be difficult, since in this case the signals in a history buffer are highly decimated sub-band samples. Instead, the G.711 PLC may be incorporated into an SBC decoder due to its merits. However, in this approach, incorporation of the PLC into an SBC decoder may not be as straightforward as it was in the G.711 decoder.

Specifically, when a single SBC packet is lost, sub-band samples in the lost packet could be considered lost. Hence, decoding of the packet or frame may be skipped, and the packet or frame may be concealed. During these processes, synthesis filter memory may not be updated. This may result in severe distortion for reconstruction of the next frame, even though the next packet is correctly received. In other words, loss of a single packet may cause waveform distortion over two frames. Hence, speech samples of more than one SBC frame size may be concealed by the PLC since more impairment in the output audio may be inevitable.

Besides the quality issue of concealed audio, incorporating G.711 PLC inherently requires a 3.75 millisecond (msec) delay, which is undesirable in delay-sensitive Bluetooth (BT) applications. Furthermore, computations required by the PLC could also be of concern, since algorithmic complexity may be significantly increased compared to complexity of the G.711 PLC for Narrow Band (NB) speech. Specifically, since the length of sample blocks used in the correlation computation may be doubled for Wideband (WB) speech PLC, the number of arithmetic operations would be increased by a factor of 4. As a result, computations for performing the PLC would far exceed the computations required for SBC decoding of a single frame. This computational burden may not be easily lifted even though an efficient technique may be employed for finding an optimal pitch lag via the coarse estimation and its refinement.

In order to tackle the performance limitations of the G.711 PLC, the systems and methods disclosed herein may allow efficient incorporation of the G.711 PLC within the SBC decoding structure. The systems and methods disclosed herein may exploit all available information at SBC decoder in concealing distorted samples and in performing pitch analysis.

Similar to G.711 PLC, correctly received packets may be decoded and stored in a history buffer. In addition to the time domain samples, a number of first sub-band samples decoded may also be stored in a sub-band buffer (of smaller size, for example).

When an SBC packet is lost, the lost sub-band samples in the lost frame may be estimated with zero. With the sub-band samples set to zero, one or more synthesis filters may output a zero-input response. Since synthesis filter states may be reset to zero during synthesizing the zero-input response, the next frame reconstruction when a packet is correctly received may be a zero-state response. In one example, a zero-state response in a subsequent frame may follow a zero-input response in a lost frame. For example, when a first packet is lost, the decoder will output the zero-input response. A second frame may then be correctly received. Waveform distortion may be observed over both of the two frames even when only one packet is lost.

Thus, although loss of a single packet may cause waveform distortion over two frames, the first few milliseconds (msec) of the zero-input response in the lost frame and the last few msec in the next frame may be reconstructed closely to the original signal. Thus, the samples in-between the two parts may be estimated via the G.711 PLC. The estimated samples may be inserted via tail and head OLAs with the neighboring samples. By exploiting the zero-input and zero-state responses of the synthesis filter in an SBC decoder, the 3.75 msec delay inherently required by the G.711 PLC may be avoided.

The approach of fully utilizing all available information may also be applied in the pitch analysis. To conceal the distorted samples in the lost and next frames, the previous frame may be similarly searched by using coarse estimation and its refinement as deployed in G.711 PLC. However, a coarse estimate may be differently obtained by computing the normalized correlations (e.g., autocorrelations) of the stored sub-band samples. Since the correlations are computed for 8-times decimated sub-band samples, for example, a significant reduction in terms of the number of computations and memory usage may be achieved. For example, when the maximum allowable pitch lag is defined as 240 samples for WB speech, the correlation computation may be performed for two blocks of 240 samples, and the history buffer may store at least 2*240 samples. However, using sub-band samples according to the systems and methods disclosed herein, the maximum allowable pitch lag may also be eight-times decimated to 30 samples. The correlations may be computed for two blocks of 30 samples, and so only 2*30 samples may need to be stored in the sub-band buffer.

The coarse estimate may then be refined using the time domain samples in the history buffer. In G.711 PLC, refinement is performed by computing normalized correlations between blocks in the last two pitch periods for each refinement candidate. For this, time domain samples of two times the maximum pitch lag may need to be stored in the history buffer. To lift such a burden on memory usage, the systems and methods disclosed herein employ an efficient scheme for pitch refinement that allows a reduction of the history buffer size by half (to the maximum pitch lag, for example). For example, the systems and methods disclosed herein may use the first few msec of samples (e.g., Pulse Code Modulated (PCM) samples) in the zero-input response of the lost frame and use it as the first argument in the correlation computation. The second argument may be one-pitch-lagged samples in the history buffer for each pitch refinement candidate. Using these two short blocks, the correlation may be efficiently computed. The correlations may be used to select as a final output of the pitch analysis the pitch lag that maximizes the correlations. This approach may be justified from an observation that the first few msec of the zero-input response in the lost frame may be reconstructed closely to the original signal and the correlations between two short blocks away by a pitch lag may yield accurate refinement results.

Another contribution to complexity reduction may be made by computing the first few msec of the zero-input response by feeding only a first few sub-band samples (set to zeros) to synthesis filters. The number of computations and memory usage required by the pitch analysis may be significantly reduced by applying the systems and methods disclosed herein for minimal computations and memory usage. Thus, the algorithmic complexity of the PLC may be maintained similar to that of normal SBC decoding.

The samples identified as the last pitch period may be repeated, and the repeated pitch periods or samples of the last pitch period may be copied into the lost frame. For a smooth transition between the received and concealed frames, OLA may be performed between the first few msec of the zero-input response and the one-pitch-lagged samples in the history buffer. The concealed or reconstructed block (e.g., packet or frame) may be output to a decoder output buffer without extra delay that occurs in G.711 PLC. The last pitch period may be repeated with fade-in signal attenuation until a next good packet is received at the decoder.

When the decoder is fed again with a good packet, decoded sub-band samples may be applied to the one or more synthesis filters. However, in this case, it may output a zero-state response due to the filter states being reset to zero. Hence, the zero-state response over the first 5 msec may be replaced with the last pitch period continued from the previous frame, for example. The last pitch period may be continued again over a few more msec for the head OLA with the corresponding fraction in the zero-state response. In this way, a seamless transition may be achieved from the concealed frame to the decoded frame. The filled frame may be directed to the decoder output buffer without extra delay otherwise required for OLAs between decoded and concealed frames.

The systems and methods disclosed herein for PLC for an SBC decoder may use the zero-input and zero-state responses of SBC synthesis filters for a seamless transition between concealed and decoded frames. The systems and methods disclosed herein may also allow an efficient realization of pitch analysis with reduced or minimal computations and memory usage. In general, the systems and methods disclosed herein are not limited to usage with G.711 PLC, but may be applied to the task of incorporating any PLC into an SBC decoder. For example, in some applications where audio quality is highly prioritized more than other design constraints, linear prediction-based (LP-based) PLC may be employed that estimates the lost frame via LP analysis and pitch analysis. Using the zero-input and zero-state responses of SBC synthesis filters for a seamless transition between concealed and decoded frames in PLC incorporation, the concealed frame may be seamlessly inserted into its neighboring frames. Furthermore, the pitch analysis in the LP-based PLC may be efficiently performed by using the efficient realization of pitch analysis with reduced computations and memory usage according to the systems and methods disclosed herein.

Some beneficial aspects of this packet loss concealment scheme (PLC) scheme particularly include the computation of coarse estimates utilizing auto-correlated sub-band samples in the sub-band sample buffer and the use of the zero-input response samples. This approach may reduce the computational complexity of a PLC scheme as well as memory usage. Furthermore, this approach may be beneficial, as delays that occur in other approaches do not occur in PLC according to the systems and methods disclosed herein.

Thus, improved systems and methods for Packet Loss Concealment (PLC) or lost packet reconstruction may allow efficient reconstruction of lost packets. These improved systems and methods may be applied to a sub-band coded wide-band (and/or narrow-band) speech signal. The systems and methods disclosed herein may reduce computational complexity and memory usage.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

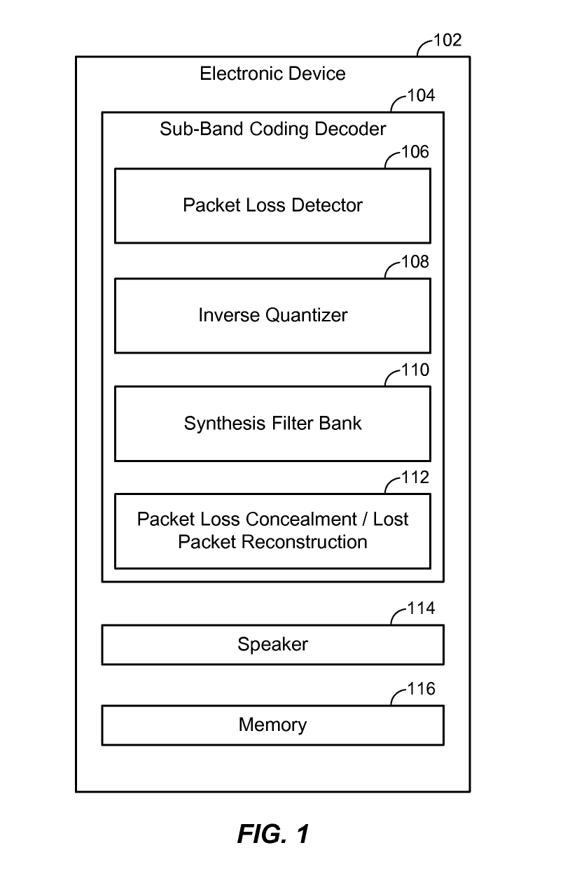

FIG. 1 is a block diagram illustrating one configuration of an electronic device 102 in which systems and methods for Packet Loss Concealment (PLC) or lost packet reconstruction may be implemented. Examples of the electronic device 102 include wireless communication devices such as cellular phones, smart phones, laptop computers, Personal Digital Assistants (PDAs), e-readers, gaming systems, wireless modems, etc. Other examples of the electronic device 102 include desktop computers, telephones, recording devices, etc. The electronic device 102 may include a Sub-Band Coding (SBC) decoder 104, one or more speakers 114 and/or memory 116. According to the systems and methods disclosed herein, the SBC decoder 104 may include a packet loss detector 106, an inverse quantizer 108, a synthesis filter bank 110 and/or a PLC/lost packet reconstruction module 112.

The packet loss detector 106 may determine when audio, voice or speech information has not been correctly received and/or decoded. In one configuration, the electronic device 102 may receive voice or speech information from another electronic device (e.g., using a wired or wireless link). In another configuration, the electronic device 102 may retrieve voice or speech information from memory 116 (e.g., RAM, hard drive, etc.). The packet loss detector 106 may determine that a packet (of the voice or speech information, for example) has been lost using error detection coding such as a CRC (Cyclic Redundancy Check). The packet loss detector 106 may otherwise determine that a packet has been lost. For example, if expected voice or speech information does not arrive within a particular time period or if the electronic device 102 is unable to properly decode received voice or speech information, the packet loss detector 106 may determine that a packet has been lost. The inverse quantizer 108 may reconstruct sub-band samples of the voice or speech signal. The synthesis filter bank 110 may comprise one or more synthesis filters and may convert the reconstructed sub-band samples into time domain (audio) samples.

The Packet Loss Concealment (PLC) or lost packet reconstruction module 112 may conceal or reconstruct lost packets. More specifically, the PLC or lost packet reconstruction module 112 may use a zero-input response of the synthesis filter bank 110 and a coarse pitch estimate (obtained using sub-band samples, for example) to obtain a fine pitch estimate. The fine pitch estimate may be used to select a last pitch period. Samples from the last pitch period may be copied or inserted into the frame of the lost packet. Thus, the lost packet may be “concealed” or reconstructed. In one configuration, the “reconstructed” packet or samples (e.g., samples in a frame that the lost packet would have occupied) may be output acoustically using one or more speakers 114. In another configuration, the “reconstructed” packet or samples may be saved to memory 116. In yet another configuration, the “reconstructed” packet or samples may be transmitted to another electronic device.

For example, when a packet is lost, the PLC/lost packet reconstruction module 112 may replace or fill the lost packet or frame with samples from a last pitch period. The last pitch period may comprise a series of samples from a preceding frame or packet. Samples from the last pitch period may be copied, inserted and/or merged into the lost or missing packet or frame. This may accordingly continue a pitch from the preceding frame. Thus, the samples placed in the lost or missing packet or frame may sound (when output as an acoustic signal) similar to the preceding frame, thus avoiding unwanted distortions. It should be noted that as used herein, the terms “reconstructing,” “reconstruct,” “concealment,” “conceal” and other variations may denote a replacement of a lost packet (or placement in a frame that the lost packet would have occupied) with other samples not from the lost packet. Thus, reconstructing a lost packet may attempt to make the packet loss less apparent to a user of the electronic device 102.

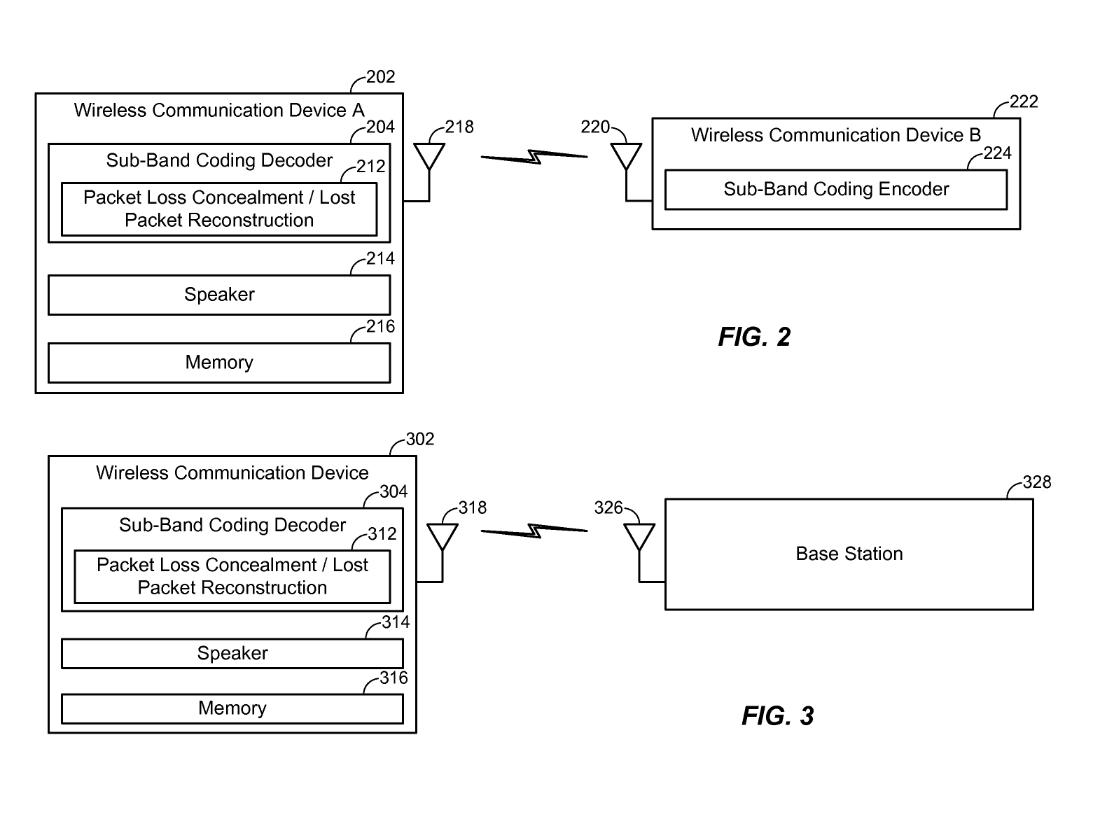

FIG. 2 is a block diagram illustrating one configuration of a wireless communication device 202 in which systems and methods for Packet Loss Concealment (PLC) or lost packet reconstruction may be implemented. Wireless communication device A 202 may include one or more antennas 218, one or more speakers 214, memory 216 and/or an SBC decoder 204, which may include a PLC or lost packet reconstruction module 212. Wireless communication device B 222 may include an SBC encoder 224 and/or one or more antennas 220. Wireless communication device A 202 and wireless communication device B 222 may communicate with each other using their respective antennas 218, 220.

Wireless communication device B 222 may use an SBC encoder 224 to encode an audio (e.g., voice or speech) signal. For example, wireless communication device B 222 may include a microphone (not shown) for capturing an audio signal (e.g., a user's voice or speech). Wireless communication device B 222 may encode the audio signal using the SBC encoder 224. The SBC encoded signal may be transmitted to wireless communication device A 202 using the one or more antennas 220. Wireless communication device A 202 may receive the SBC encoded signal using one or more antennas 218. Wireless communication device A 202 may then decode the SBC encoded signal using the SBC decoder 204. If any packets of the SBC encoded signal are lost or missing, wireless communication device A 202 may use the PLC/lost packet reconstruction module 212 to conceal or place other samples (e.g., a “reconstructed” packet) in place of the lost packet. The SBC decoded audio signal may be output acoustically using the one or more speakers 214, may be stored in memory 216 and/or may be transmitted to another electronic device or wireless communication device.

In one configuration, for example, wireless communication device B 222 is a Bluetooth headset and wireless communication device A 202 is a cellular phone. A user may use wireless communication device B 222 (e.g., the Bluetooth headset) to capture his voice or speech for a telephone call. The user's voice or speech is captured by a microphone and encoded using the SBC encoder 224. The captured/encoded speech may be wide-band speech or narrow-band speech, for example. The SBC encoded audio (e.g., voice, speech) signal is transmitted using the antenna 220, which is then received by wireless communication device A 202 (e.g., cellular phone) using the antenna 218. Wireless communication device A 202 uses the SBC decoder 204 to decode the SBC encoded signal. If a packet is lost or missing, wireless communication device A 202 uses the PLC/lost packet reconstruction module 212 to place samples from a previous frame into the frame of the lost or missing packet. The resulting SBC decoded signal is an audio signal (e.g., a wide-band or narrow-band audio signal with one or more “concealed” packets). In this example, wireless communication device A 202 (e.g., the cellular phone) may format the audio signal (e.g., add error detection/correction coding, modulate, etc.) and transmit it to another electronic device (e.g., cellular phone, landline telephone, etc.). Additionally or alternatively, the audio signal may be stored in memory 216 and/or acoustically output using the one or more speakers 214.

FIG. 3 is a block diagram illustrating another configuration of a wireless communication device 302 in which systems and methods for Packet Loss Concealment (PLC) or lost packet reconstruction may be implemented. The wireless communication device 302 may include one or more antennas 318, one or more speakers 314, memory 316 and/or an SBC decoder 304, which may include a PLC/lost packet reconstruction module 312. A base station 328 may communicate with the wireless communication device 302 using one or more antennas 326.

As discussed above, one example of the wireless communication device 302 is a cellular phone. Assume, for example, that the wireless communication device 302 (e.g., cellular phone) has received an SBC encoded audio signal from a Bluetooth headset (e.g., wireless communication device B 222 in FIG. 2). Further assume that one or more packets of the SBC encoded audio signal have been lost (e.g., not correctly received or decoded). The wireless communication device 302 decodes the received SBC encoded audio signal using the SBC decoder 304. The wireless communication device 302 also conceals or replaces the lost packet(s) using the PLC/lost packet reconstruction module 312. The resulting signal is a decoded audio signal or samples having one or more lost packets replaced with samples from another frame or packet. The decoded audio signal may then be formatted for transmission (e.g., having error correction/detection coding added, being modulated, etc.) This formatted audio signal may then be transmitted using the one or more antennas 318 and received by the base station 328 using one or more antennas 326. The base station 328 may then relay the audio signal to another electronic device. For example, the base station 328 may send the audio signal to a telephone, computing device (e.g., desktop/laptop computer) or cellular phone using the Public Switched Telephone Network (PSTN) or the Internet (through Voice over Internet Protocol (VoIP), for example). The audio signal may then be output by the electronic device (e.g., telephone, computing device, cellular phone, etc.). The wireless communication device 302 may additionally or alternatively store the decoded audio signal in memory 316 and/or output the decoded audio signal using the one or more speakers 314.

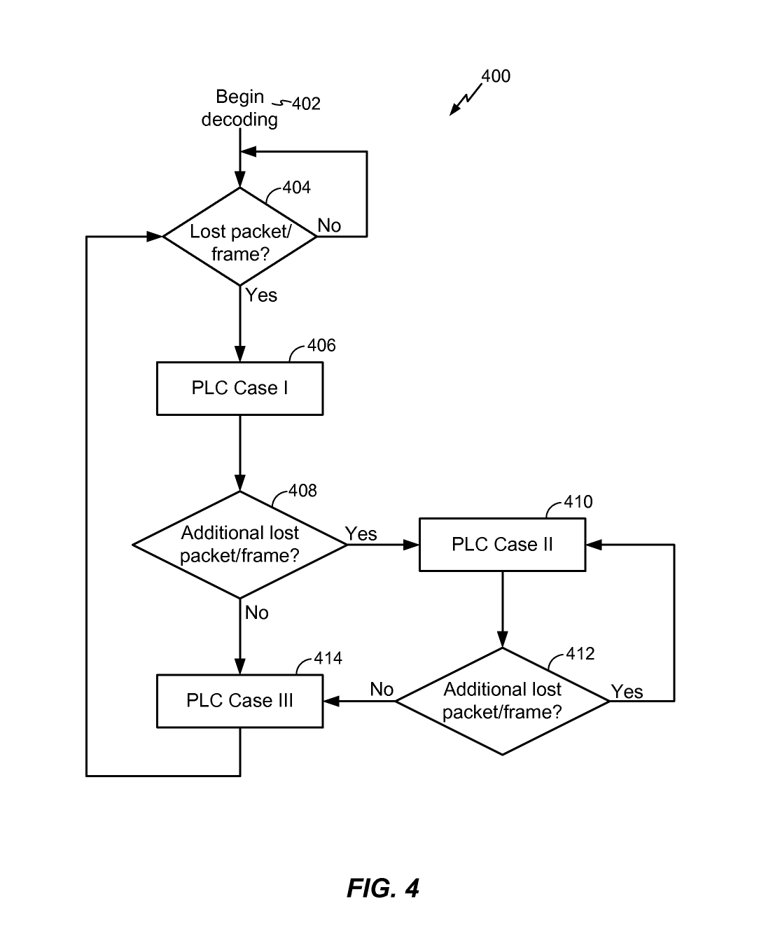

FIG. 4 is a flow diagram illustrating one configuration of a method 400 for concealing or reconstructing lost packets in a Sub-Band Coding (SBC) decoder. For example, FIG. 4 illustrates how a Packet Loss Concealment (PLC) or lost packet reconstruction module 112 may switch between three PLC cases. In general, PLC case I may denote a case where a packet or frame of SBC encoded audio has been correctly decoded, followed by a lost or incorrectly decoded packet. PLC case II may denote a case where a lost or incorrectly decoded packet is followed by an additional lost or incorrectly decoded packet. PLC case III may denote a case where a lost or incorrectly decoded packet is followed by a correctly decoded packet.

An electronic device 102 (e.g., with an SBC decoder 104 and a PLC/lost packet reconstruction module 112) may begin decoding 402 an SBC encoded audio signal (e.g., a received wideband speech bit stream). The electronic device 102 may determine 404 whether a packet has been lost (e.g., not received, incorrectly decoded, etc.). If the electronic device 102 determines 404 that a packet has not been lost, the electronic device 102 may continue to decode an SBC encoded audio signal (e.g., a received wideband speech bit stream) until a lost packet is detected or determined 404. If the electronic device 102 determines 404 that a packet has been lost, it 102 may perform 406 PLC case I. In performing 406 PLC case I, the electronic device 102 may determine a last pitch period. The last pitch period may be a number of samples from a correctly decoded packet. The electronic device 102 may place or copy one or more samples from the last pitch period into the lost packet or frame. More detail on performing 406 PLC case I is given below.

The electronic device 102 may determine 408 (once PLC Case I is performed 406, for example) whether there is an additional lost packet. If the electronic device 102 determines 408 that there is not an additional lost packet, the electronic device 102 may perform 414 PLC case III. In performing 414 PLC case III, the electronic device 102 may place or copy one or more samples from the last pitch period into the correctly decoded packet or frame or a portion of the decoded packet or frame. This may be done, for example, to transition into good or desirable samples from the correctly decoded packet. More detail on performing 414 PLC case III is given below. The electronic device 102 (e.g., SBC decoder 104) may return to determine 404 whether there is a lost packet in the SBC encoded audio signal (e.g., bit stream). This may be done, for example, following performance 414 of PLC Case III.

If the electronic device 102 determines 408 that there is an additional lost packet (after performing 406 PLC case I, for example), the electronic device 102 (e.g., SBC decoder 104) may perform 410 PLC case II. In performing 410 PLC case II, the electronic device 102 may place or copy samples from the (originally determined) last pitch period into the additional lost packet or frame. This may be done repeatedly as needed to fill the lost packet or frame. The electronic device 102 may also fade (e.g., progressively decrease the volume or amplitude) the placed or copied samples in the additional lost packet(s) or frame(s). The electronic device 102 may determine 412 whether there is an additional lost packet. If there is an additional lost packet, the electronic device 102 may again perform 410 PLC case II by placing or copying samples from the last pitch period into the additional lost packets or frames and/or by continuing to fade the samples. If the electronic device 102 determines 412 that there is not an additional lost packet (e.g., a viable packet has been received), the electronic device 102 may perform 414 PLC case III and return to determine 404 whether there is a lost packet (after performing 414 PLC case III, for example).

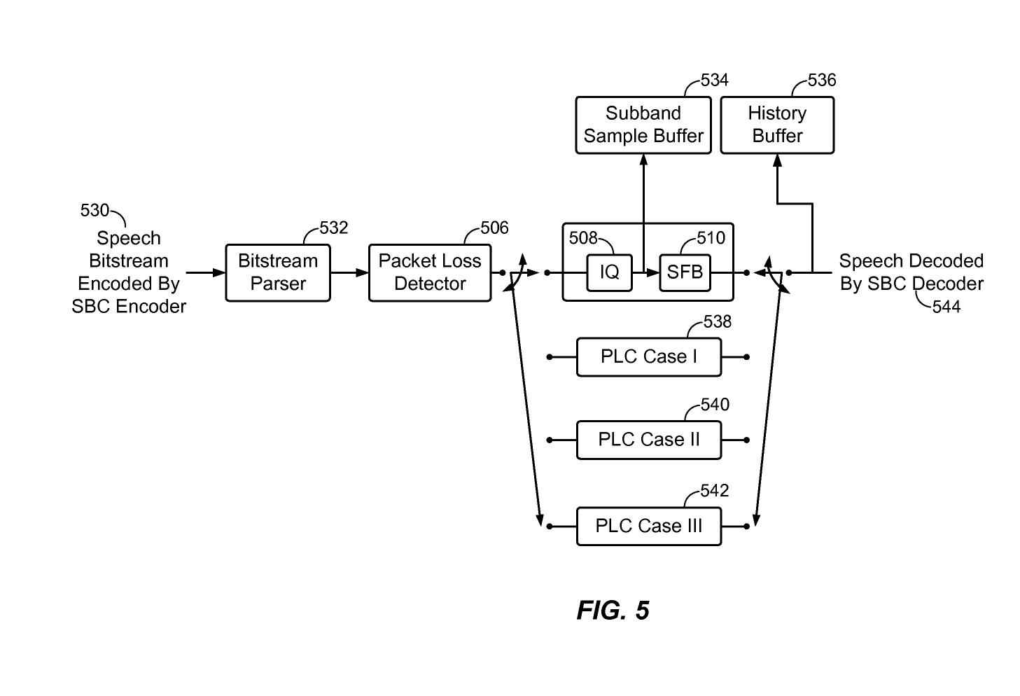

FIG. 5 is a block diagram illustrating one configuration of several modules for concealing or reconstructing lost packets in a Sub-Band Coding (SBC) decoder. A speech bit stream (e.g., wideband speech bit stream) 530 encoded by an SBC encoder may be input into a bit stream parser 532. A bit stream parser 532 may parse the bit stream and may provide the following decoder with information on bit error detection and data reconstruction. The parsed bit stream may be input into a packet loss detector 506. The packet loss detector 506 may determine when audio, voice or speech information has not been correctly received and/or decoded. The packet loss detector 506 may determine that a packet (of the voice or speech information, for example) has been lost using error detection coding such as a CRC (Cyclic Redundancy Check). The packet loss detector 506 may otherwise determine that a packet has been lost. For example, if expected voice or speech information does not arrive within a particular time period or if the electronic device 102 is unable to properly decode received voice or speech information, the packet loss detector 506 may determine that a packet has been lost.

The packet loss detector 506 may be used to determine how the SBC decoder 104 may operate. For example, if the packet loss detector 506 does not detect any lost packets, the SBC decoder 104 may operate by directly using the inverse quantizer 508 (abbreviated as “IQ” in FIG. 5 for convenience) and synthesis filter bank 510 (abbreviated as “SFB” in FIG. 5 for convenience) to produce speech 544 (e.g., speech samples) decoded by the SBC decoder 104. The inverse quantizer 508 may reconstruct sub-band samples of the voice or speech signal. The reconstructed sub-band samples may be input into or stored in a sub-band sample buffer 534. The synthesis filter bank 510 may convert the reconstructed sub-band samples into time domain samples of speech 544 decoded by the SBC decoder 104. These speech samples 544 may also be stored in a history buffer 536. For example, the history buffer 536 may include Pulse Code Modulated (PCM) speech samples.

If the packet loss detector 506 detects a lost packet following a correctly decoded packet, the electronic device 102 may switch to and/or perform PLC case I 538. That is, PLC case 1538 may be performed in the case where at least one packet has been correctly decoded, followed by a lost or missing packet. PLC case 1538 may be denoted as (0, x), where the 0 represents a correctly decoded packet or frame and x represents a missing or lost packet. PLC case II 540 may be performed when the packet loss detector 506 detects an additional missing or lost packet following a missing or lost packet (e.g., (x, x)). PLC case III 542 may be performed when the packet loss detector 506 detects a correctly decoded packet following a missing or lost packet (e.g., (x, 0)). When operating according to PLC case 1538, PLC case II 540 or PLC case III 542, the electronic device 102 may produce speech 544 (e.g., wideband speech) samples decoded by the SBC decoder 104 using some packet concealment or reconstruction. More detail on PLC case 1538, PLC case II 540 and PLC case III 542 is given below.

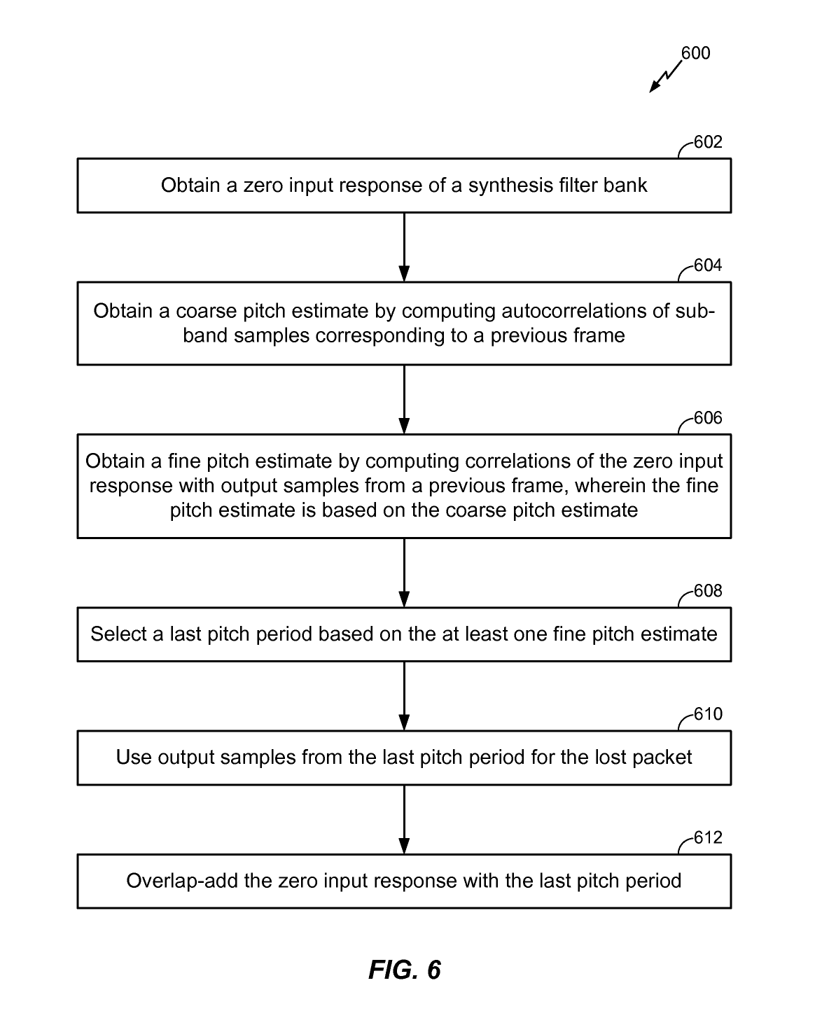

FIG. 6 is a flow diagram illustrating a more specific configuration of a method 600 for concealing or reconstructing lost packets in a Sub-Band Coding (SBC) decoder. More specifically, FIG. 6 illustrates more detail on performing 406 PLC case I, for example. The electronic device 102 may obtain 602 a zero-input response of a synthesis filter bank. For example, when the electronic device 102 (e.g., packet loss detector 106) detects a missing or lost packet following a correctly decoded packet, the electronic device 102 may input zeros (e.g., samples of zero) into the synthesis filter bank 110. The synthesis filter bank 110 may output a zero-input response, which may reflect some residual data from the previous frame. The zero-input response (e.g., a useful number of samples of the zero-input response) may occupy a portion of the lost packet or frame.

The electronic device 102 may obtain 604 a coarse pitch estimate by computing autocorrelations of sub-band samples corresponding to a previous frame (e.g., a range of time occupied by the previous frame). For example, the electronic device 102 may compute autocorrelations of a range of sub-band samples from the sub-band sample buffer 534. In one configuration (and as illustrated in FIG. 5), the sub-band samples used may have been output by the inverse quantizer 508. In this configuration, the sub-band samples before synthesis (e.g., before being synthesized by the synthesis filter bank 510) may be directly used to compute the autocorrelations.

The electronic device 102 may obtain 606 at least one fine pitch estimate by computing correlations (e.g., normalized correlations) of the zero-input response with output samples from the previous frame. The at least one fine pitch estimate may be based on the at least one coarse pitch estimate. For example, the electronic device 102 (e.g., SBC decoder 104) may compute correlations of the zero-input response samples with speech samples from the history buffer 536 in a range around the coarse pitch estimate (or around a sample in the history buffer 536 corresponding to the coarse pitch estimate). The maximum correlation may indicate or correspond to the fine pitch estimate. For example, a sample in the history buffer 536 corresponding to the maximum correlation may be selected as the fine pitch estimate.

The electronic device 102 may select 608 a last pitch period based on the fine pitch estimate. For example, the last pitch period may be selected 608 as the samples from the fine pitch estimate to the end of the frame (in the history buffer 536, for example) The electronic device 102 may use 610 output samples from the last pitch period for the lost packet. For example, the electronic device 102 may copy or place samples from the last pitch period (in the history buffer 536, for example) into the lost packet or frame. Repeated last pitch periods may be used to fill the lost packet or frame. For example, samples from the last pitch period in the history buffer 536 may be repeatedly copied or placed in the lost packet or frame until the lost packet or frame is full. The electronic device 102 may overlap-add 612 the zero-input response samples (e.g., a number of zero-input response samples or the useful zero-input response samples) with the last pitch period samples in the lost packet or frame. For example, a number of zero-input response samples occupying the lost packet or frame (e.g., the beginning of the lost packet or frame) may be overlap-added 612 with a number of the last pitch period samples.

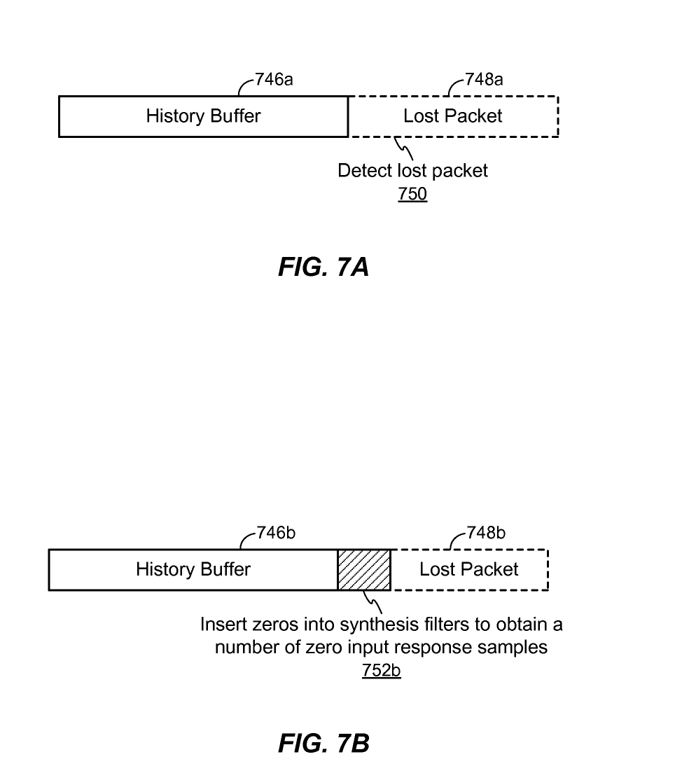

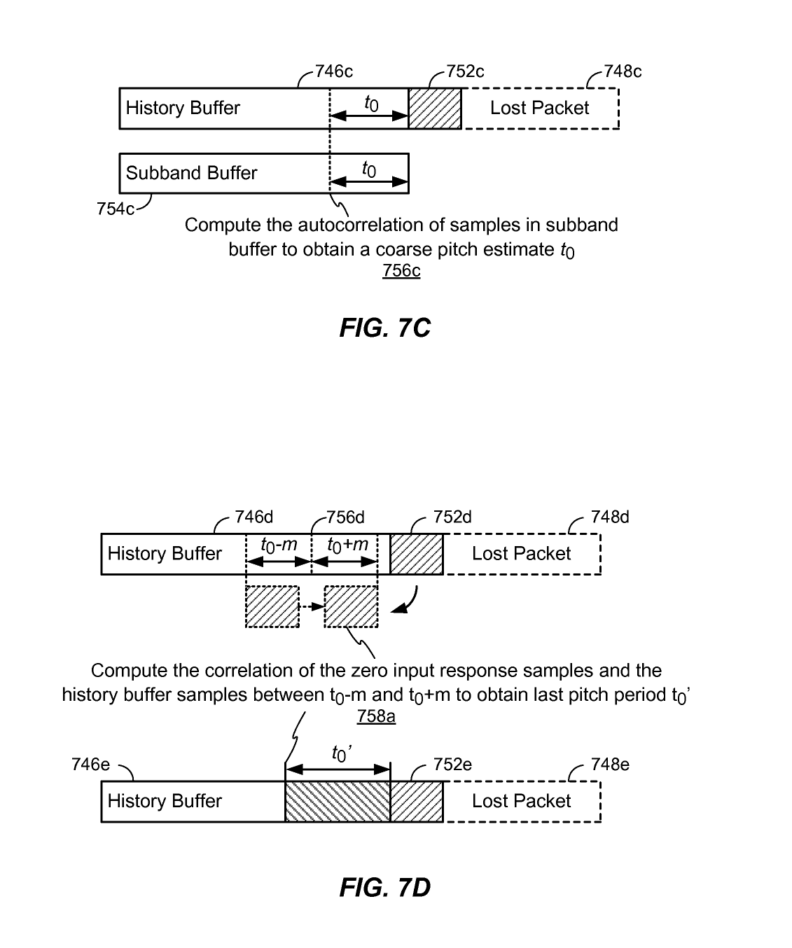

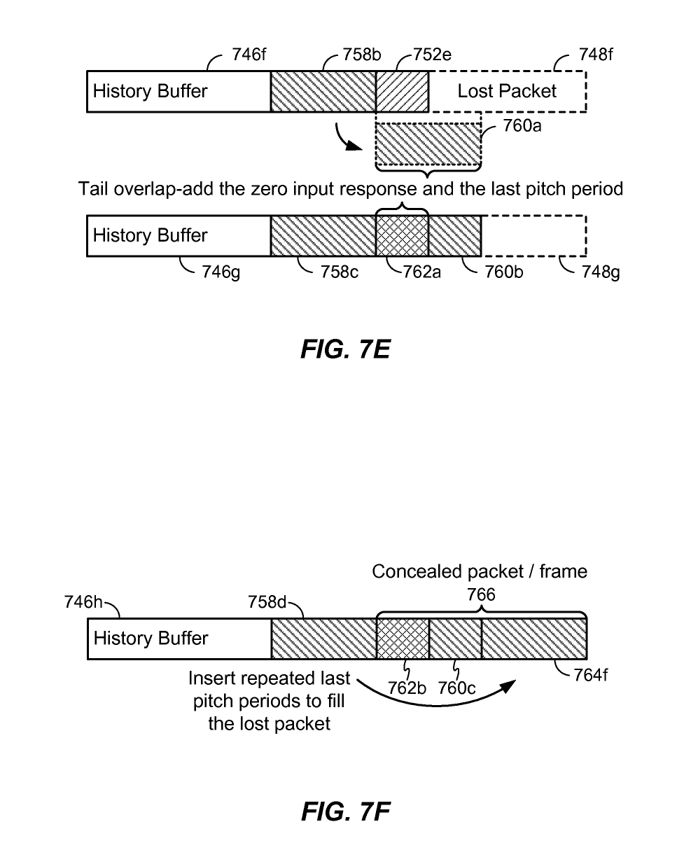

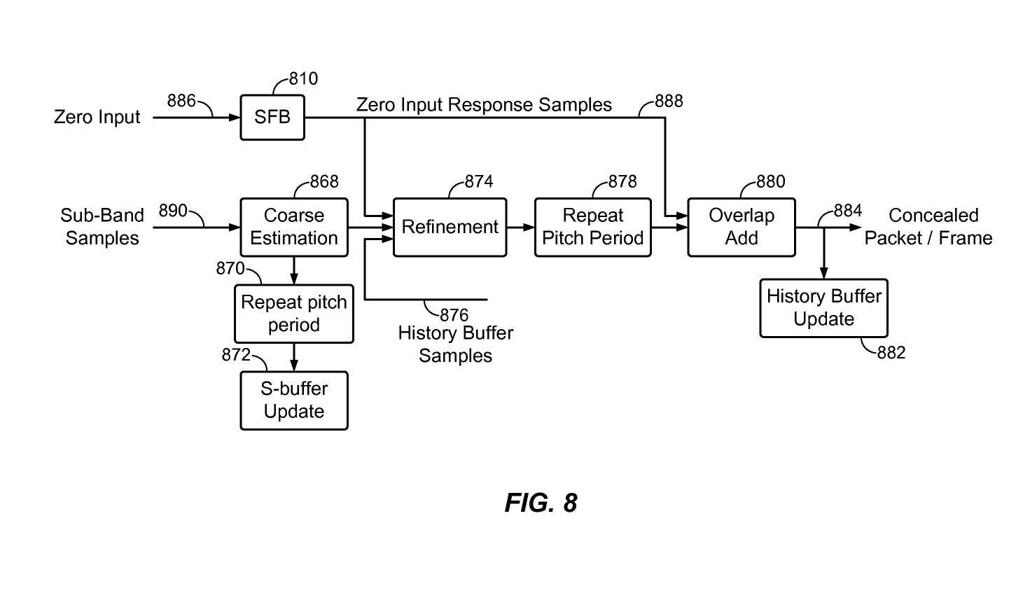

FIGS. 7A-7F are diagrams illustrating more detail regarding concealing or reconstructing lost packets in a sub-band coding decoder. More specifically, FIGS. 7A-7F illustrate operations that may be performed according to PLC case I, for example.

FIG. 7A illustrates lost or missing packet detection. An electronic device 102 may receive and/or decode SBC encoded audio (e.g., voice or speech). For example, an SBC decoder 104 may decode the SBC encoded speech to produce decoded speech samples. These decoded speech samples may be PCM samples, for example. Decoded speech samples may be stored in a history buffer 746a. The electronic device 102 may detect 750 a lost packet 748a. For example, if a packet is not correctly received and/or decoded, a lost packet 748a may be detected.

FIG. 7B illustrates the generation of a zero-input response 752b. When a lost packet 748b is detected 750, the electronic device 102 may insert a number of zeros into the synthesis filter bank 110 in order to obtain a number of zero-input response samples 752b. Inserting zeros into the synthesis filter bank 110 may generate zero-input response samples 752b that residually reflect earlier decoded audio (e.g., voice or speech) samples, which may be stored in the history buffer 746b. According to the systems and methods disclosed herein, the history buffer 746 may have a length of a maximum allowable pitch lag (which may be shorter than (e.g., half of) a traditional history buffer length). The length of the maximum allowable pitch lag may correspond to a maximum speech and/or voice wavelength.

FIG. 7C illustrates the determination of a coarse pitch estimate or period 756c. In particular, FIG. 7C illustrates a history buffer 746c, a number of zero-input response samples 752c, a lost packet 748c, a sub-band buffer 754c and a coarse pitch estimate 756c. The sub-band buffer 754c may store a number of sub-band samples. The sub-band samples may be sub-band samples that have not been synthesized (e.g., by the synthesis filter bank 110). The electronic device 102 may compute an autocorrelation of samples in the sub-band buffer in order to obtain a coarse pitch estimate t₀ 756c. The coarse pitch estimate t₀ 756c may be a time instant or sample corresponding to the maximum autocorrelation value within in the range of computed autocorrelations. The range of computed autocorrelations may correspond to a maximum allowable pitch lag. As illustrated in FIG. 7C, the coarse pitch estimate t₀ 756c may correspond to a particular time or sample number in the history buffer 746c.

FIG. 7D illustrates the determination of a fine pitch estimate and/or last pitch period. FIG. 7D particularly illustrates a history buffer 746d-e, a number of zero-input response samples 752d-e, a lost packet 748d-e, a coarse pitch estimate 756d and a fine pitch estimate indicating a last pitch period t₀′ 758a. Correlations of the zero-input response samples 752d and samples in the history buffer 746d may be computed by the electronic device 102 in a range of ±m samples around the coarse pitch estimate 756d. The range of samples may be, for example, between the coarse pitch estimate sample and neighboring candidates (denoted t₀−m and t₀+m, for example). For example, m may be the number of history buffer samples per sub-band sample. The maximum correlation in this range indicates a last pitch period t₀′ 758a in the history buffer 746e. For example, the last pitch period 758a may include the samples from the fine pitch estimate to the end of the packet or frame.

FIG. 7E illustrates using a last pitch period 758b-c for the lost packet 748f-g and “tail” overlap-adding a zero-input response 752e with samples from the last pitch period 760a-b. In particular, FIG. 7E illustrates a history buffer 746f-g, a last pitch period 758b-c indicated by a fine pitch estimate, a number of samples or a copy of the last pitch period 760a-b, a zero-input response 752e, a lost packet 748f-g and overlap-added zero-input response samples with the number of samples or copy of the last pitch period 762a. The electronic device 102 may use samples from the last pitch period 758b, which may be a copy of the last pitch period 760a. The last pitch period samples 760a may replace or be used in place of the lost packet 748f. For example, the last pitch period samples 760a may be overlap-added to the zero-input response samples 752e. This may result in a number of overlap-added samples 762a and a remaining portion of the last pitch period samples 760b that are not overlap-added.

FIG. 7F illustrates a concealed or reconstructed packet or frame 766. In particular, FIG. 7F illustrates a history buffer 746h, a last pitch period 758d, a number of overlap-added zero-input response and last pitch period samples 762b, a remaining portion of a last pitch period samples 760c that are not overlap-added, a repeated last pitch period 764f and a concealed or reconstructed packet (or frame, for example) 766. If a portion of the lost packet 748 is not filled, the electronic device 102 may insert repeated last pitch periods 764f until the lost packet 748 is entirely filled. These operations may result in a concealed packet 766 (or frame, for example). It should be noted that although the fine pitch estimates or last pitch periods are sometimes illustrated herein as fitting evenly within a lost packet, this may not necessarily be the case in all configurations or instances. For example, the last pitch period may overlap between lost (or between a lost and correctly received) packet (or frame, for example). Furthermore, in one configuration, the fine pitch estimates or last pitch periods may use a fade-out/in approach to reduce discontinuities between adjacent and/or overlapping pitch periods.

FIG. 8 is a block diagram illustrating one configuration of several modules for concealing or reconstructing lost packets in a Sub-Band Coding (SBC) decoder. More specifically, FIG. 8 illustrates one configuration of modules that may be used when a correctly received and/or decoded packet is followed by a lost or missing packet (e.g., PLC case I). In particular, FIG. 8 illustrates a synthesis filter bank (illustrated as “SFB” in FIG. 8 for convenience) module 810, a coarse estimation module 868, a first repeat period module 870, a sub-band buffer update module 872, a refinement module 874, a second repeat pitch period module 878, an overlap-add module 880 and a history buffer update module 882. The modules illustrated in FIG. 8 may be implemented as hardware, software or a combination of both.

In the case where a correctly decoded packet is followed by a detected lost or missing packet (e.g., PLC case I), the electronic device 102 may provide a zero-input 886 to the synthesis filter bank module 810. For example, the zero-input 886 may comprise a number of zero samples. The synthesis filter bank 810 may use the zero-input 886 to produce zero-input response samples 888. The zero-input response samples 888 may comprise a number of zero-input response samples 888 that occupy some or all of the lost packet or frame. In one configuration, the number of zeros input into the synthesis filter bank 810 may be fewer than the number of samples in a packet or frame. For example, 24 zeros may be inserted into the synthesis filter bank 810. For instance, the zero-input 886 may comprise a matrix X(k, m), where X(k, m)=0 for 1≦k≦8 and 1≦m≦3. The synthesis filter bank 810 may thus output 24 zero-input response samples 888.

The electronic device 102 may use a number of sub-band samples 890 to perform coarse estimation 868. For example, the sub-band samples 890 may be sub-band (e.g., decimated sub-band) samples that have not passed through the synthesis filter bank 810 that are stored in a sub-band buffer. The sub-band samples may additionally or alternatively be a number of “first” sub-band samples from the sub-band buffer. That is, the sub-band samples may be samples from a first sub-band buffer. The coarse estimation module 868 may use the sub-band samples 890 to determine a coarse pitch estimate. For example, the coarse estimation module 868 may compute autocorrelations over a number of sub-band samples 890 from the sub-band buffer. The maximum autocorrelation value may indicate a coarse pitch estimate. The coarse pitch estimate may indicate a time instant or sample of the maximum autocorrelation. Obtaining a coarse pitch estimate in this way may reduce the number of computations needed to determine a last pitch period, for example.

A refinement module 874 may use the zero-input response samples 888, the coarse estimate from the coarse estimation module 868 and a number of history buffer samples 876 to determine a fine pitch estimate and/or last pitch period (in the history buffer, for example). For example, the refinement module 874 may compute (normalized) correlations of the zero-input response samples 888 and the history buffer samples 876 in a range around the coarse pitch estimate (for a number of “candidates,” for example). This may be deemed “refinement” and may provide a fine pitch estimate in the history buffer. The fine pitch estimate may correspond to the maximum correlation of the zero-input response samples 888 and the history buffer samples 876 in the computed range. A last pitch period may be selected based on the fine pitch estimate. The last pitch period may comprise a number of samples from the history buffer. For example, the last pitch period may include each of the history buffer samples 876 from the fine pitch estimate to the end of the frame or packet in the history buffer. Thus, the last pitch period may be selected based on the fine pitch estimate.

The second repeat pitch period module 878 may repeat the last pitch period in the lost packet or frame. For example, the second repeat pitch period module 878 may copy or place samples from the last pitch period in the history buffer into the lost packet or frame. For instance, the second repeat pitch period module 878 may repeat samples in the history buffer for lost sample concealment as well as for the history buffer update. The last pitch period may be repeated as needed to fill the lost packet or frame. The overlap-add module 880 may overlap-add a number of the last pitch period samples with the zero-input response samples in the lost packet or frame. This may produce a concealed packet or frame 884. The history buffer may then be updated by the history buffer update module 882. The first repeat pitch period module 870 may repeat sub-band samples in the sub-band buffer corresponding to the previous frame. Thus, the sub-band buffer may be updated by the S-buffer update module 872. For example, the first repeat pitch period module 870 may repeat sub-band samples in the sub-band buffer only for a first sub-band.

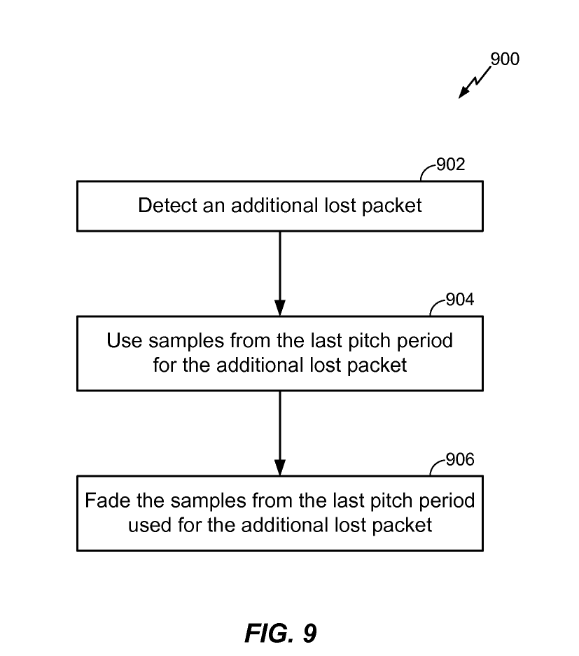

FIG. 9 is a flow diagram illustrating another configuration of a method 900 for concealing or reconstructing lost packets in a Sub-Band Coding (SBC) decoder. More specifically, FIG. 9 illustrates a case where an additional lost packet is detected following a lost packet (e.g., PLC case II). The electronic device 102 may detect 902 an additional lost packet. For example, the packet loss detector 106 may detect a subsequent lost packet following a previous lost packet. The electronic device 102 may use 904 output samples from the last pitch period for the additional lost packet. For example, the electronic device 102 may copy or place output samples from the last pitch period (which was determined for a first lost packet, for example) into the additional lost packet or frame. Repeated last pitch periods or samples from the last pitch period may be used as needed to fill the lost packet or frame. The electronic device 102 may fade 906 the output samples from the last pitch period used for the additional lost packet. For example, the electronic device 102 may decrease the volume or amplitude of the samples from the last pitch period that have been used for the lost packet or frame.

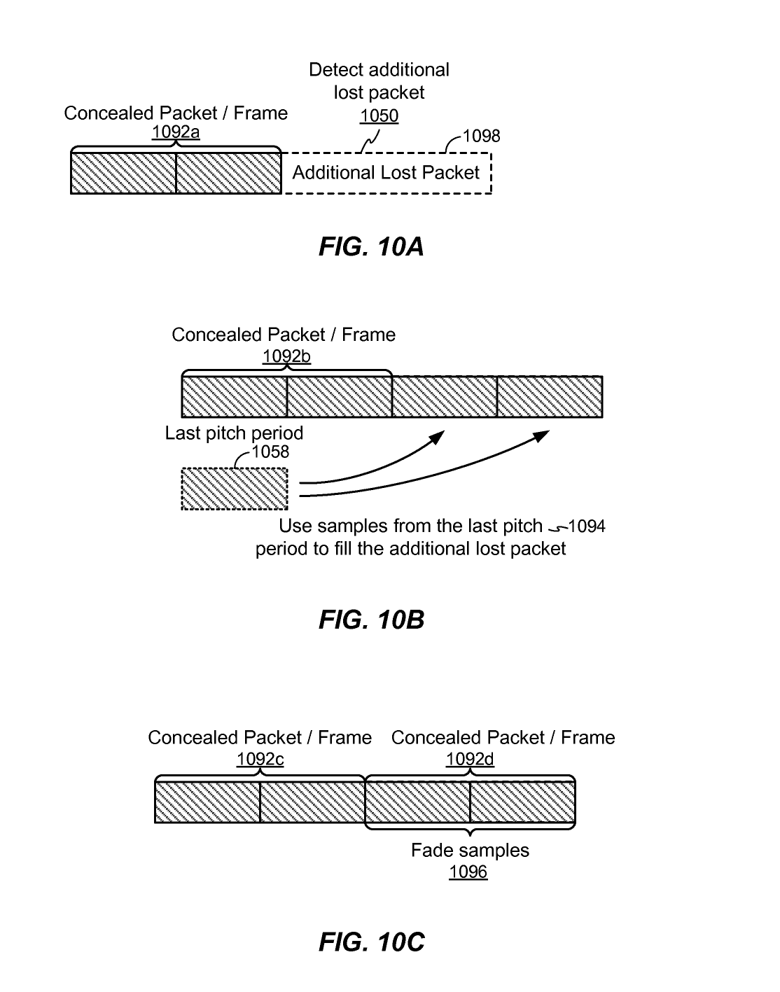

FIGS. 10A-C are diagrams illustrating lost packet concealment or reconstruction for an additional lost packet. FIGS. 10A-10C illustrate PLC case II, for example.

FIG. 10A is a diagram illustrating the detection of an additional lost packet. For example, the packet loss detector 106 may detect 1050 an additional lost packet 1098. For instance, the electronic device 102 may have generated a concealed or reconstructed packet or frame 1092a for a previous lost packet. Following the concealed or reconstructed packet or frame 1092a, the electronic device 102 may detect 1050 an additional lost packet 1098.

FIG. 10B is a diagram illustrating using samples from a last pitch period to conceal or reconstruct an additional lost packet or frame 1098. For example, the electronic device 102 may have previously determined a last pitch period 1058 in the history buffer (which may have been used to generate a concealed packet or frame 1092b). The electronic device 102 may use 1094 samples from the last pitch period 1058 for the additional lost packet. For example, the electronic device 102 may copy or place samples from the last pitch period 1058 into the additional lost packet 1098. Repeated last pitch periods 1058 or repeated samples from the last pitch period 1058 may be copied or placed into the additional lost packet or frame 1098 as needed in order to fill the additional lost packet or frame 1098.

FIG. 10C is a diagram illustrating fading 1096 samples in a concealed packet or frame 1092d. The electronic device may fade 1096 samples of a concealed packet or frame 1092d. As used herein, the term “fade” may denote progressively reducing the volume or amplitude of a series of samples. In one configuration, for example, the electronic device 102 may fade 1096 samples in a subsequent concealed packet or frame 1092d following a previous concealed packet or frame 1092c. In other configurations, fading 1096 may be started in a first concealed packet or frame 1092c or in later concealed packets or frames 1092 (e.g., a third concealed packet or frame, etc.).

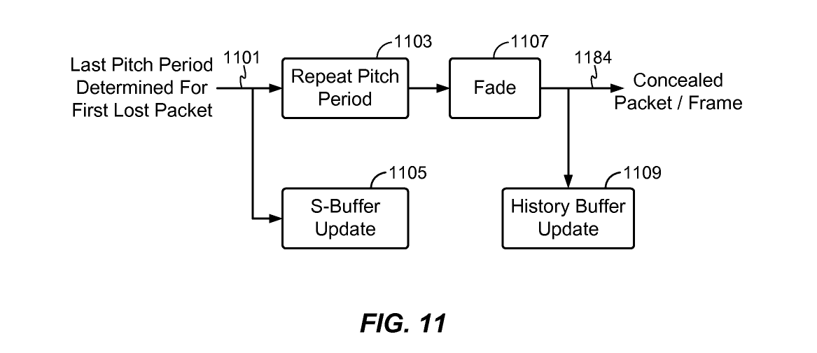

FIG. 11 is a block diagram illustrating one configuration of several modules that may be used for concealing or reconstructing lost packets in a Sub-Band Coding (SBC) decoder. For example, FIG. 11 illustrates modules that may be used in a case where an additional lost packet follows a previous lost packet (e.g., PLC case II). The modules illustrated in FIG. 11 may be implemented in hardware, software or a combination of both. In particular, FIG. 11 illustrates a repeat pitch period module 1103, a sub-band buffer update module (illustrated as “S-buffer update” for convenience in FIG. 11) 1105, a fade module 1107 and a history buffer update module 1109.

The repeat pitch period module 1103 may use the last pitch period or the pitch analysis determined for a first lost packet 1101. For example, the repeat pitch period module 1103 may repeat (e.g., copy or place) samples from last pitch period into the additional lost packet or frame. Repeated pitch periods or samples from the last pitch period may be copied or placed in the additional lost packet or frame as needed to fill the additional lost packet or frame. A sub-band buffer may be updated by the S-buffer update module 1105. For example, sub-band samples in the sub-band buffer corresponding to previous packet or frame samples may be repeated. This may be done for a first sub-band as described above.

The fade-out module 1107 may be used to progressively reduce the volume or amplitude of the last pitch period samples in the additional lost packet or frame. This may produce a concealed or reconstructed packet or frame 1184. The history buffer may be updated by the history buffer update module 1109 (with the repeated last pitch period samples, for example). In one configuration, the fade-out may continue into further additional lost packets or frames until the volume or amplitude reaches 0, for example. The fade-out may be used to avoid creating strange artifacts in the resulting audio signal. For example, as the period of packet/frame concealment gets longer, the synthesized signal used to conceal missing packets or frames may diverge from the real signal. Thus, a fade-out or attenuation may be used to avoid creating strange-sounding artifacts (e.g., since even a synthesized signal that sounds natural in isolation may sound strange if held out for too long). In one configuration, the first concealed packet or frame may not use a fade-out or attenuation. However, a linear attenuation of the synthesized signal may begin at the start of the second concealed packet or frame (e.g., with a 20% attenuation rate per frame). In this example configuration, the synthesized signal may be attenuated to zero after several concealed packets or frames.

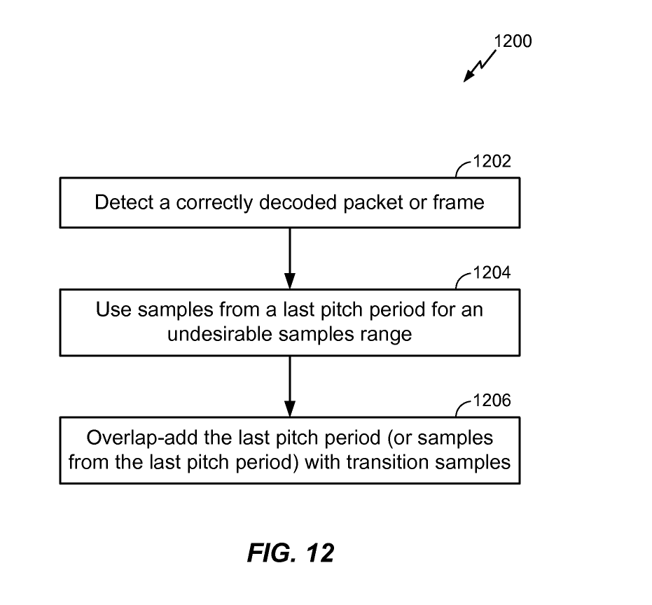

FIG. 12 is a flow diagram illustrating one configuration of a method 1200 for concealing or reconstructing lost packets in a Sub-Band Coding (SBC) decoder. More specifically, FIG. 12 illustrates a case where a correctly received and/or decoded packet follows a lost packet or frame (e.g., PLC case III). For example, the method 1200 illustrated in FIG. 12 may be used for a correctly decoded packet or frame following a concealed or reconstructed packet or frame.

The electronic device 102 may detect 1202 a correctly decoded packet or frame. For example, the electronic device 102 may receive and/or decode a packet or frame without the packet loss detector 106 indicating a lost packet. The electronic device 102 may use 1204 samples from a last pitch period for an undesirable samples range. For example, because zeros may have been previously input into the synthesis filter bank 110, the synthesis filter bank 110 may exhibit a zero-state response when viable or “good” data is input. This may result in a number or range of undesirable samples at the beginning of a correctly decoded packet or frame. Thus, the electronic device 102 may use (e.g., copy or place) samples from the last pitch period into the undesirable samples range. For example, a number of samples from the last pitch period (previously determined for the first lost packet, for example) may replace the samples in the range of undesirable samples in the correctly decoded packet or frame. The electronic device 102 may overlap-add 1206 the last pitch period or samples from a last pitch period with a number of transition samples. For example, the transition samples may be a number of samples between the undesirable samples and desirable decoded samples.

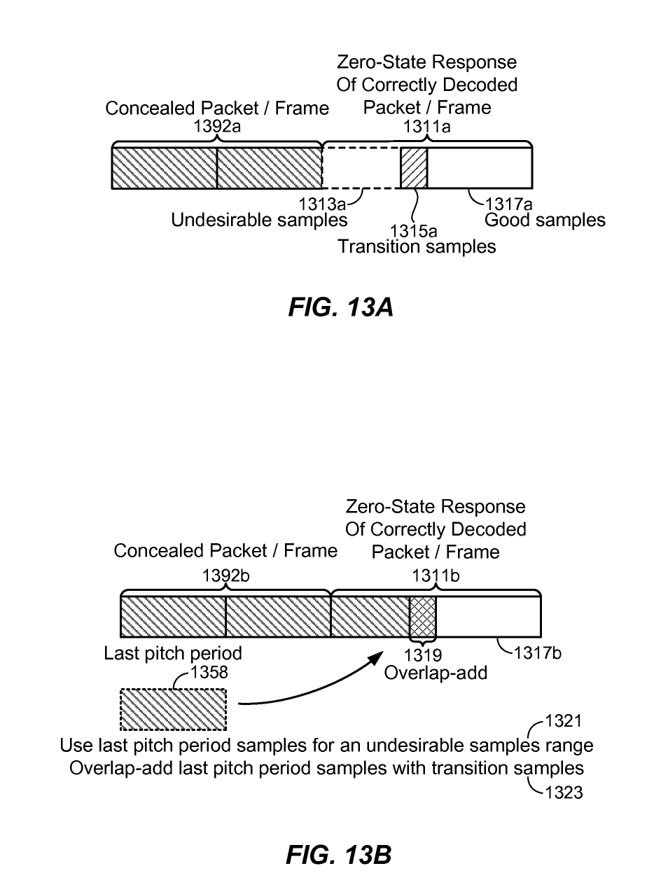

FIGS. 13A-B are diagrams illustrating a case where a correctly decoded packet or frame follows a lost packet or frame. For example, FIGS. 13A-B illustrate PLC case III.

FIG. 13A is a diagram illustrating a zero-state response of a correctly decoded packet or frame 1311a. For example, an electronic device 102 may have generated one or more concealed or reconstructed packets or frames 1392a for one or more lost packets or frames. As described above, the electronic device 102 may input zeros into the synthesis filter bank 110 in order to produce a zero-input response for a lost packet or frame. As a result, when a viable or good packet or frame is decoded, the synthesis filter bank 110 may exhibit a zero-state response of a correctly decoded packet or frame 1311a. Thus, a correctly decoded packet or frame may include a number of undesirable samples 1313a, a number of transition samples 1315a and a number of desirable or good samples 1317a. The beginning of the zero-state response may be constructed with reduced (e.g., half) information. Thus, its waveform may seem distorted and may not be used for decoder or concealment output. These samples may be the undesirable samples 1313a. As the synthesis filter bank 110 gets more sub-band samples, filter memory is gradually updated towards a correct or desirable output. That is, the synthesis filter bank 110 outputs transition samples 1315a as it gets closer to outputting correct or desirable samples 1317a. The synthesis filter bank 110 eventually outputs a correct output or desirable samples 1317a. Three regions may thus be observed and/or determined empirically depending on the length of synthesis filter memory and by observing waveform reconstruction.

FIG. 13B is a diagram illustrating using samples from a last pitch period 1358 for the zero-state response of a correctly decoded packet or frame 1311b. An electronic device 102 may use 1321 last pitch period 1358 samples for a zero-state response of a correctly decoded packet or frame 1311b. The electronic device 102 may have previously determined the last pitch period 1358 for a first lost packet to generate a concealed packet or frame 1392b, for example. In one configuration, a number of samples from the last pitch period 1358 may be used 1321 to replace (or be placed in place of) a number of undesirable samples 1313a. The undesirable samples 1313a may be at the beginning of the zero-state response of a correctly decoded packet or frame 1311b, for example. The electronic device 102 may also overlap-add 1323 a number of last pitch period 1358 samples with transition samples 1315a to generate overlap-added samples 1319. These overlap-added samples 1319 may be in a transition range. The desirable or good samples 1317b may fill the remainder of the correctly decoded packet or frame 1311b.

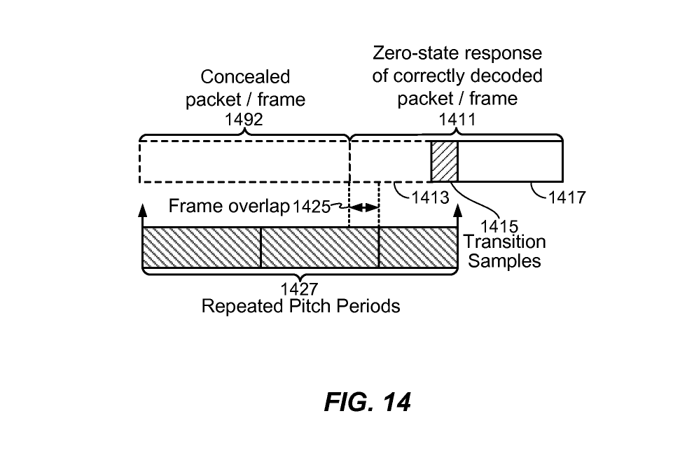

FIG. 14 is a diagram illustrating an example of frame overlap 1425. The example of frame overlap 1425 illustrated in FIG. 14 is given in the context of FIG. 13. However, frame overlap 1425 may also occur in the context of FIG. 10. For example, a repeated pitch period may overlap 1425 a packet or frame boundary. When this occurs, the remaining samples from a repeated pitch period 1427 in a previous (e.g., concealed or reconstructed) packet or frame 1492 may be included at the beginning of the following packet or frame (e.g., zero-state response packet/frame 1411 or additional lost packet/frame 1098). In the example shown in FIG. 14, some samples remaining in a repeated pitch period 1427 from the concealed packet or frame 1492 may be inserted within the “undesirable samples” 1413 portion of the zero-state response of the correctly decoded packet or frame 1411. Following these remaining samples, additional repeated pitch period samples may then be inserted and overlap-added with transition samples 1415 as described above in connection with FIG. 13. In this example, the desirable or good samples 1417 may fill the remainder of the zero-state response of a correctly decoded packet or frame 1411.

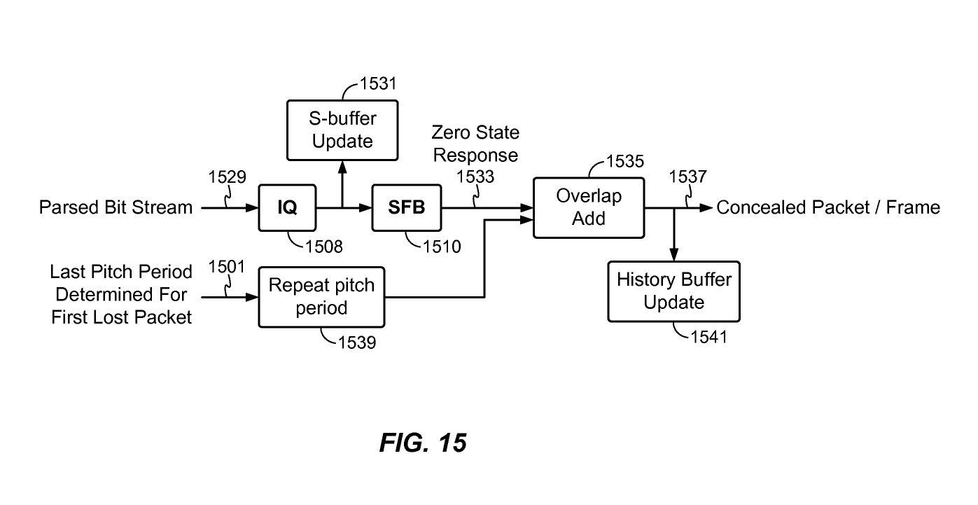

FIG. 15 is a block diagram illustrating one configuration of several modules that may be used for concealing or reconstructing lost packets in a Sub-Band Coding (SBC) decoder. For example, FIG. 15 illustrates a case where a viable or good packet is received or decoded following a lost packet or frame (e.g., PLC case III). The lost packet or frame may have been concealed or reconstructed by the electronic device 102. In particular, FIG. 15 illustrates an inverse quantizer 1508 (illustrated as “IQ” in FIG. 15 for convenience), sub-band buffer update module 1531 (illustrated as “S-Buffer Update” in FIG. 15 for convenience), a synthesis filter bank 1510 (illustrated as “SFB” in FIG. 15 for convenience), an overlap-add module 1535, a repeat pitch period module 1539 and a history buffer update module 1541.

An inverse quantizer 1508 may use a parsed bit stream 1529 to produce sub-band samples. The sub-band samples may be used by the sub-band buffer update module 1531 to update the sub-band buffer. The sub-band samples may also be input into a synthesis filter bank 1510. In one configuration, 120 sub-band samples are input into the synthesis filter bank 1510 in a matrix form X(k, m), where 1≦k≦8 and 1≦m≦15. As described above, zeros may be input into the synthesis filter bank 1510 when a first lost packet it detected. As a result, when viable or “good” sub-band samples are input into the synthesis filter bank 1510, the synthesis filter bank 1510 may produce a zero-state response 1533. As described above, a number of initial samples of the zero-state response 1533 may be undesirable samples followed by a number of transition samples followed by a number of desirable or good samples.

The repeat pitch period module 1539 may use previous pitch analysis or samples from a last pitch period determined for a first lost packet 1501 for the zero-state response 1533 packet or frame. For example, the electronic device 102 may replace the undesirable samples with samples from the last pitch period 1501. The electronic device 102 may also use an overlap-add module 1535 to overlap-add a number of last pitch period samples 1501 with a number of transition samples. This may produce a concealed packet or frame 1537. In this case, the concealed packet or frame 1537 may not be a lost packet or frame, but may be a concealed zero-state response of a viable packet or frame. For example, the undesirable samples and/or the transition samples in the zero-state response 1533 may be concealed or reconstructed. The resulting concealed packet or frame 1537 may be used by the history buffer update module 1541 to update the history buffer.

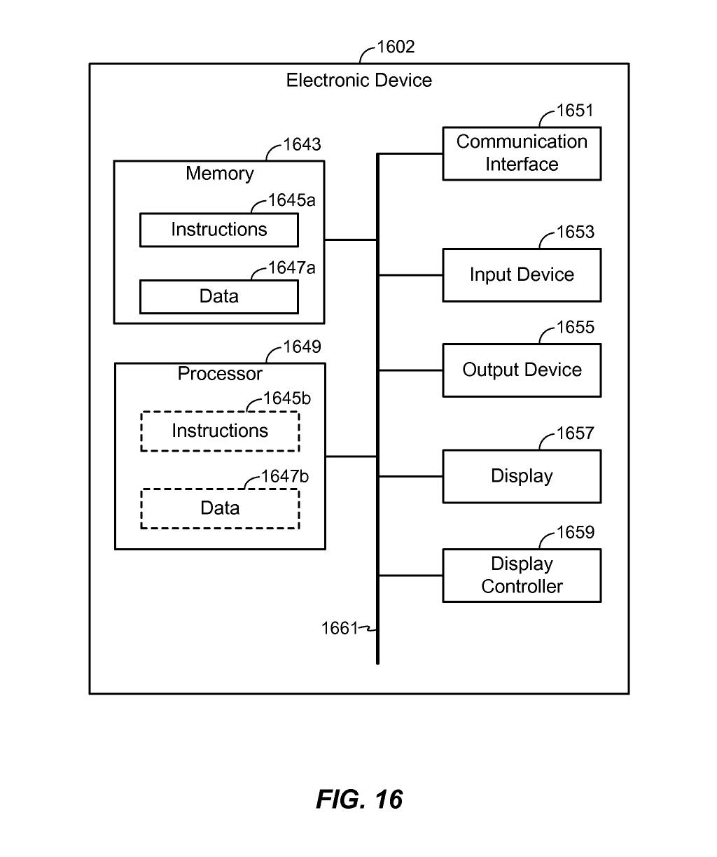

FIG. 16 illustrates various components that may be utilized in an electronic device 1602. The illustrated components may be located within the same physical structure or in separate housings or structures. The electronic device 102 discussed in relation to FIG. 1 may be configured similarly to the electronic device 1602. The electronic device 1602 includes a processor 1649. The processor 1649 may be a general purpose single- or multi-chip microprocessor (e.g., an ARM), a special purpose microprocessor (e.g., a digital signal processor (DSP)), a microcontroller, a programmable gate array, etc. The processor 1649 may be referred to as a central processing unit (CPU). Although just a single processor 1649 is shown in the electronic device 1602 of FIG. 16, in an alternative configuration, a combination of processors (e.g., an ARM and DSP) could be used.

The electronic device 1602 also includes memory 1643 in electronic communication with the processor 1649. That is, the processor 1649 can read information from and/or write information to the memory 1643. The memory 1643 may be any electronic component capable of storing electronic information. The memory 1643 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1647a and instructions 1645a may be stored in the memory 1643. The instructions 1645a may include one or more programs, routines, sub-routines, functions, procedures, code, etc. The instructions 1645a may include a single computer-readable statement or many computer-readable statements. The instructions 1645a may be executable by the processor 1649 to implement the methods 400, 600, 900, 1200 that were described above. Executing the instructions 1645a may involve the use of the data 1647a that is stored in the memory 1643. FIG. 16 shows some instructions 1645b and data 1647b being loaded into the processor 1649.

The electronic device 1602 may also include one or more communication interfaces 1651 for communicating with other electronic devices. The communication interfaces 1651 may be based on wired communication technology, wireless communication technology, or both. Examples of different types of communication interfaces 1651 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The electronic device 1602 may also include one or more input devices 1653 and one or more output devices 1655. Examples of different kinds of input devices 1653 include a keyboard, mouse, microphone, remote control device, button, joystick, trackball, touchpad, lightpen, etc. Examples of different kinds of output devices 1655 include a speaker, printer, etc. One specific type of output device that may be typically included in an electronic device 1602 is a display device 1657. Display devices 1657 used with configurations disclosed herein may utilize any suitable image projection technology, such as a cathode ray tube (CRT), liquid crystal display (LCD), light-emitting diode (LED), gas plasma, electroluminescence, or the like. A display controller 1659 may also be provided for converting data stored in the memory 1643 into text, graphics and/or moving images (as appropriate) shown on the display device 1657.

The various components of the electronic device 1602 may be coupled together by one or more buses, which may include a power bus, a control signal bus, a status signal bus, a data bus, etc. For simplicity, the various buses are illustrated in FIG. 16 as a bus system 1661. It should be noted that FIG. 16 illustrates only one possible configuration of an electronic device 1602. Various other architectures and components may be utilized.

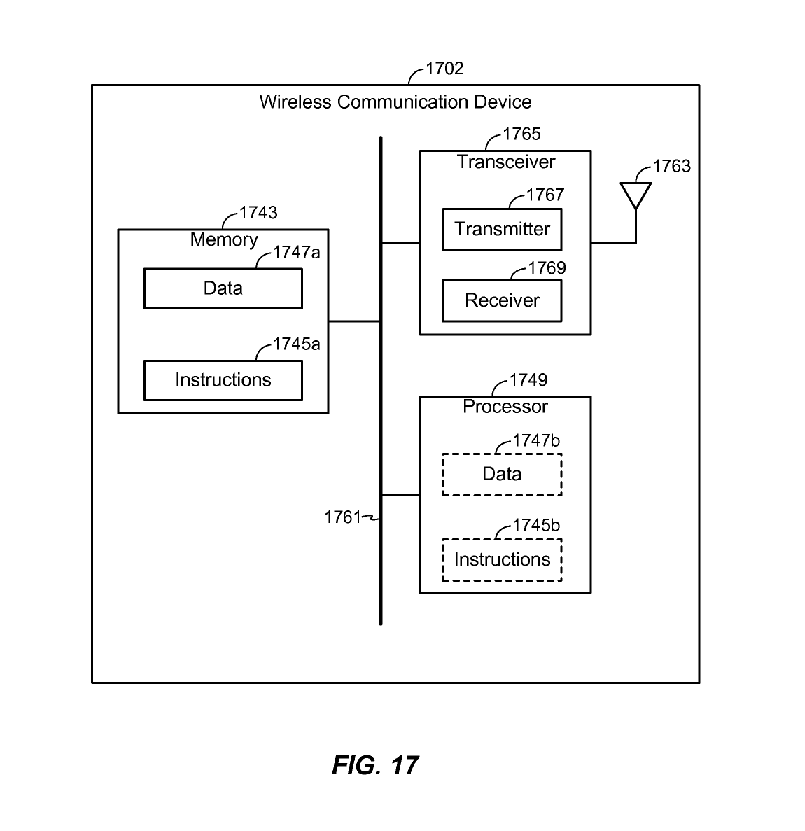

FIG. 17 illustrates certain components that may be included within a wireless communication device 1702. The wireless communication devices 202, 222, 302 described previously may be configured similarly to the wireless communication device 1702 that is shown in FIG. 17. The wireless communication device 1702 includes a processor 1749. The processor 1749 may be a general purpose single- or multi-chip microprocessor (e.g., an ARM), a special purpose microprocessor (e.g., a digital signal processor (DSP)), a microcontroller, a programmable gate array, etc. The processor 1749 may be referred to as a central processing unit (CPU). Although just a single processor 1749 is shown in the wireless communication device 1702 of FIG. 17, in an alternative configuration, a combination of processors (e.g., an ARM and DSP) could be used.

The wireless communication device 1702 also includes memory 1743 in electronic communication with the processor 1749 (i.e., the processor 1749 can read information from and/or write information to the memory 1743). The memory 1743 may be any electronic component capable of storing electronic information. The memory 1743 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1747a and instructions 1745a may be stored in the memory 1743. The instructions 1745a may include one or more programs, routines, sub-routines, functions, procedures, etc. The instructions 1745a may include a single computer-readable statement or many computer-readable statements. The instructions 1745a may be executable by the processor 1749 to implement the methods 400, 600, 900, 1200 that were described above. Executing the instructions 1745a may involve the use of the data 1747a that is stored in the memory 1743. FIG. 17 shows some instructions 1745b and data 1747b being loaded into the processor 1749.

The wireless communication device 1702 may also include a transmitter 1767 and a receiver 1769 to allow transmission and reception of signals between the wireless communication device 1702 and a remote location (e.g., a base station or other wireless communication device). The transmitter 1767 and receiver 1769 may be collectively referred to as a transceiver 1765. An antenna 1763 may be electrically coupled to the transceiver 1765. The wireless communication device 1702 may also include (not shown) multiple transmitters, multiple receivers, multiple transceivers and/or multiple antenna.

The various components of the wireless communication device 1702 may be coupled together by one or more buses, which may include a power bus, a control signal bus, a status signal bus, a data bus, etc. For simplicity, the various buses are illustrated in FIG. 17 as a bus system 1761.

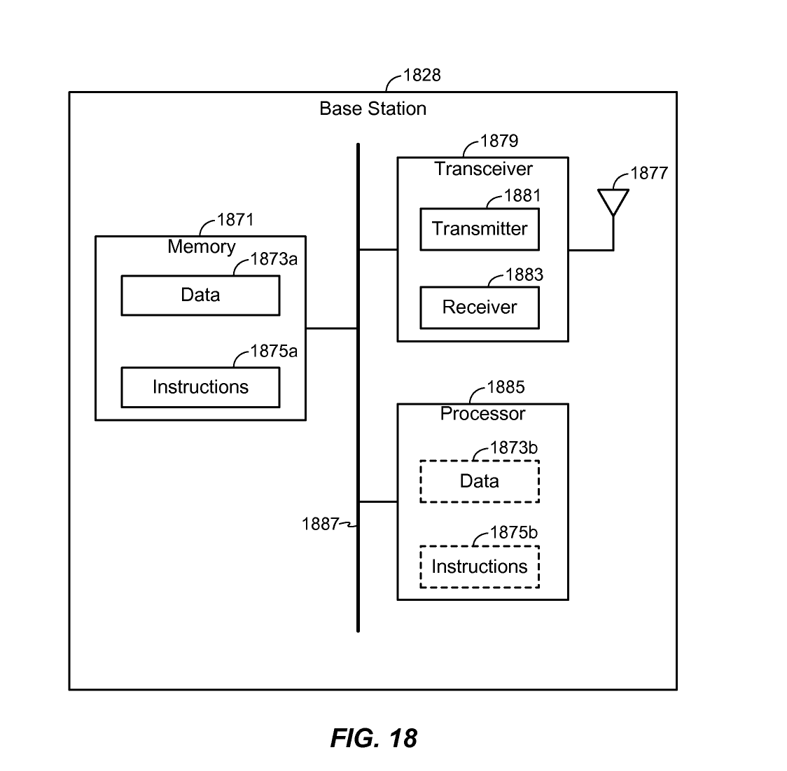

FIG. 18 illustrates certain components that may be included within a base station 1828. The base station 328 discussed previously may be configured similarly to the base station 1828 shown in FIG. 18. The base station 1828 includes a processor 1885. The processor 1885 may be a general purpose single- or multi-chip microprocessor (e.g., an ARM), a special purpose microprocessor (e.g., a digital signal processor (DSP)), a microcontroller, a programmable gate array, etc. The processor 1885 may be referred to as a central processing unit (CPU). Although just a single processor 1885 is shown in the base station 1828 of FIG. 18, in an alternative configuration, a combination of processors (e.g., an ARM and DSP) could be used.

The base station 1828 also includes memory 1871 in electronic communication with the processor 1885 (i.e., the processor 1885 can read information from and/or write information to the memory 1871). The memory 1871 may be any electronic component capable of storing electronic information. The memory 1871 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1873a and instructions 1875a may be stored in the memory 1871. The instructions 1875a may include one or more programs, routines, sub-routines, functions, procedures, etc. The instructions 1875a may include a single computer-readable statement or many computer-readable statements. The instructions 1875a may be executable by the processor 1885. Executing the instructions 1875a may involve the use of the data 1873a that is stored in the memory 1871. FIG. 18 shows some instructions 1875b and data 1873b being loaded into the processor 1885.

The base station 1828 may also include a transmitter 1881 and a receiver 1883 to allow transmission and reception of signals between the base station 1828 and a remote location (e.g., a wireless communication device). The transmitter 1881 and receiver 1883 may be collectively referred to as a transceiver 1879. An antenna 1877 may be electrically coupled to the transceiver 1879. The base station 1828 may also include (not shown) multiple transmitters, multiple receivers, multiple transceivers and/or multiple antenna.

The various components of the base station 1828 may be coupled together by one or more buses, which may include a power bus, a control signal bus, a status signal bus, a data bus, etc. For simplicity, the various buses are illustrated in FIG. 18 as a bus system 1887.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

1. An electronic device for reconstructing a lost packet in a Sub-Band Coding (SBC) decoder, comprising:
a processor;
memory in electronic communication with the processor;
instructions stored in the memory, the instructions being executable to:
detect a lost packet;
obtain a zero-input response of a synthesis filter bank;
obtain a coarse pitch estimate;
obtain a fine pitch estimate based on the zero-input response and the coarse pitch estimate;
select a last pitch period based on the fine pitch estimate; and
use samples from the last pitch period for the lost packet.

2. The electronic device of claim 1, wherein the coarse pitch estimate is obtained by computing autocorrelations of sub-band samples.

3. The electronic device of claim 2, wherein the sub-band samples have not been synthesized.

4. The electronic device of claim 1, wherein the instructions are further executable to overlap-add at least some of the samples from the last pitch period with the zero-input response.

5. The electronic device of claim 1, wherein the fine pitch estimate is obtained by computing correlations of the zero-input response with previously decoded samples.

6. The electronic device of claim 1, wherein the instructions are further executable to:
detect an additional lost packet; and
use samples from the last pitch period for the additional lost packet.

7. The electronic device of claim 6, wherein the instructions are further executable to fade the samples from the last pitch period.

8. The electronic device of claim 6, wherein the instructions are further executable to use samples from the last pitch period for a plurality of additional lost packets.

9. The electronic device of claim 1, wherein the instructions are further executable to:
detect a correctly decoded packet or frame;
use samples from the last pitch period for a range of undesirable samples; and
overlap-add samples from the last pitch period with transition samples.

10. The electronic device of claim 1, wherein using the samples from the last pitch period for the lost packet comprises copying the samples into the lost packet.

11. The electronic device of claim 1, wherein the SBC decoder is used to decode wide-band speech signals.

12. The electronic device of claim 1, wherein the electronic device is a wireless communication device.

13. The electronic device of claim 12, wherein the wireless communication device is a Bluetooth device.

14. The electronic device of claim 1, wherein no additional delay is used for reconstructing the lost packet compared to decoding a viable packet by the SBC decoder.

15. A method for reconstructing a lost packet in a Sub-Band Coding (SBC) decoder, comprising:
detecting a lost packet;
obtaining, on an electronic device, a zero-input response of a synthesis filter bank;
obtaining a coarse pitch estimate;
obtaining, on the electronic device, a fine pitch estimate based on the zero-input response and the coarse pitch estimate;
selecting a last pitch period based on the fine pitch estimate; and
using samples from the last pitch period for the lost packet.

16. The method of claim 15, wherein the coarse pitch estimate is obtained by computing autocorrelations of sub-band samples.

17. The method of claim 16, wherein the sub-band samples have not been synthesized.

18. The method of claim 15, further comprising overlap-adding at least some of the samples from the last pitch period with the zero-input response.

19. The method of claim 15, wherein the fine pitch estimate is obtained by computing correlations of the zero-input response with previously decoded samples.

20. The method of claim 15, further comprising:
detecting an additional lost packet; and
using samples from the last pitch period for the additional lost packet.

21. The method of claim 20, further comprising fading the samples from the last pitch period.

22. The method of claim 20, further comprising using samples from the last pitch period for a plurality of additional lost packets.

23. The method of claim 15, further comprising:
detecting a correctly decoded packet or frame;
using samples from the last pitch period for a range of undesirable samples; and
overlap-adding samples from the last pitch period with transition samples.

24. The method of claim 15, wherein using the samples from the last pitch period for the lost packet comprises copying the samples into the lost packet.

25. The method of claim 15, wherein the SBC decoder is used to decode wide-band speech signals.

26. The method of claim 15, wherein the electronic device is a wireless communication device.

27. The method of claim 26, wherein the wireless communication device is a Bluetooth device.

28. The method of claim 15, wherein no additional delay is used for reconstructing the lost packet compared to decoding a viable packet by the SBC decoder.

29. A computer-program product for reconstructing a lost packet in a Sub-Band Coding (SBC) decoder, the computer-program product comprising a non-transitory tangible computer-readable medium having instructions thereon, the instructions comprising:
code for causing an electronic device to detect a lost packet;
code for causing the electronic device to obtain a zero-input response of a synthesis filter bank;
code for causing the electronic device to obtain a coarse pitch estimate;
code for causing the electronic device to obtain a fine pitch estimate based on the zero-input response and the coarse pitch estimate;
code for causing the electronic device to select a last pitch period based on the fine pitch estimate; and
code for causing the electronic device to use samples from the last pitch period for the lost packet.

30. The computer-program product of claim 29, wherein the coarse pitch estimate is obtained by computing autocorrelations of sub-band samples.

31. The computer-program product of claim 29, the instructions further comprising:
code for causing the electronic device to detect an additional lost packet; and
code for causing the electronic device to use samples from the last pitch period for the additional lost packet.

32. The computer-program product of claim 29, the instructions further comprising:
code for causing the electronic device to detect a correctly decoded packet or frame;
code for causing the electronic device to use samples from the last pitch period for a range of undesirable samples; and
code for causing the electronic device to overlap-add samples from the last pitch period with transition samples.

33. An apparatus for reconstructing a lost packet in a Sub-Band Coding (SBC) decoder, comprising:
means for detecting a lost packet;
means for obtaining a zero-input response of a synthesis filter bank;
means for obtaining a coarse pitch estimate;
means for obtaining a fine pitch estimate based on the zero-input response and the coarse pitch estimate;
means for selecting a last pitch period based on the fine pitch estimate; and
means for using samples from the last pitch period for the lost packet.

34. The apparatus of claim 33, wherein the coarse pitch estimate is obtained by computing autocorrelations of sub-band samples.

35. The apparatus of claim 33, further comprising:
means for detecting an additional lost packet; and
means for using samples from the last pitch period for the additional lost packet.

36. The apparatus of claim 33, further comprising:
means for detecting a correctly decoded packet or frame;
means for using samples from the last pitch period for a range of undesirable samples; and
means for overlap-adding samples from the last pitch period with transition samples.
